(19) United States
(12) Patent Application Publication
(10) Pub. No.: US 2011/0119660 A1
(43) Pub. Date: May 19, 2011

(54) PROGRAM CONVERSION APPARATUS AND PROGRAM CONVERSION METHOD

(75) Inventor: Akira TANAKA, Osaka (JP)

(73) Assignee: PANASONIC CORPORATION, Osaka (JP)

(21) Appl. No.: 13/013,367

(22) Filed: Jan. 25, 2011

Related U.S. Application Data
(63) Continuation of application No. PCT/JP2009/001932, filed on Apr. 28, 2009.

(30) Foreign Application Priority Data
Jul. 31, 2008 (JP) 2008-198375

(51) Int. Cl. G06F 9/45

(52) U.S. Cl. 717/149

(57) ABSTRACT

A program conversion apparatus according to the present invention includes: a thread creation unit which creates a plurality of threads equivalent to a program part included in a program, based on path information on a plurality of execution paths, each of the execution paths going from a start to an end of the program part, each of the threads being equivalent to at least one of the execution paths; a replacement unit which performs variable replacement on the threads so that a variable shared by the threads is accessed by only to one of the threads in order to avoid an access conflict among the threads; and a thread parallelization unit which generates a program which causes the threads to be speculatively executed in parallel after the variable replacement.

### CROSS REFERENCE TO RELATED APPLICATION

This is a continuation application of PCT application No. PCT/JP2009/001932 filed on Apr. 28, 2009, designating the United States of America.

### BACKGROUND OF THE INVENTION

(1) Field of the Invention

The present invention relates to a program conversion apparatus and a program conversion method, and particularly relates to a program conversion technique for converting an execution path of a specific part of a program into a plurality of speculatively-executable threads so as to reduce a program execution time.

(2) Description of the Related Art

In recent years, there has been qualitative and quantitative expansion of multimedia processing and enhancement of communication speed for a digital TV, a Blu-ray recorder, and a cellular phone. Also, there have been quantitative expansion of interface processing performed by, typically, game machines. In view of these enhancement and expansions, demands for improvement in performance of processors installed in consumer embedded devices continue to grow.

Also, recent advances in the semiconductor technology is providing an environment where, as processors installed in consumer embedded devices, a processor capable of concurrently executing multiple program parts (i.e., threads) by a multiprocessor architecture and a processor with a parallel execution function of concurrently executing multiple threads by a single-processor architecture can be used at low cost.

For a program conversion apparatus, such as a complier, which makes effective use of such processors, it is important to efficiently employ computational resources of the processor in order to cause a program to be executed at higher speed.

A program conversion method for a processor having such a thread parallelization function is disclosed in Japanese Unexamined Patent Application Publication No. 2006-154971 (referred to as Patent Reference 1).

According to the method disclosed in Patent Reference 1, a specific part of a program is threaded for each of the execution paths and optimization is performed for each of the threads. With this method, multiple threads are executed in parallel so that the specific part of the program can be executed in a short time. Major factors for the fast execution include the optimization specialized for a specific execution path and the parallel execution of the generated threads.

In general, only one execution path is selected as the execution path of a specific part of the program, and is accordingly executed. However, the program conversion apparatus disclosed in Patent Reference 1 concurrently executes the threads, each generated for each execution path, and thus executes the paths which are not supposed to be selected originally. That is to say, this program conversion apparatus performs the “speculative” thread execution. In other words, Patent Reference 1 provides the program conversion apparatus which performs “software-thread speculative conversion” whereby execution paths of a specific part of the program are converted into speculatively-executable threads.

For example, as shown in FIG. 38 (which corresponds to FIG. 3 in Patent Reference 1), a thread 301, a thread 302, and a thread 303 are generated from a thread 300 which is a program part before conversion. Here, I, J, K, Q, S, L, U, T, and X in the thread 300 indicate basic blocks. The basic blocks do not include branches nor merges within the thread and are executed successively. The instructions in a basic block are executed in order from an entry to an exit of the basic block. In the present diagram, the arrows from the basic blocks indicate the execution transition. For instance, the arrows from the exit of the basic block I indicate branches to the basic blocks J and X, respectively. Note that, at the beginning of the basic block, there may be a merge from another basic block. Also note that, at the end of the basic block, there may be a branch to another basic block.

The present diagram also shows that the basic blocks I, J, and Q of the thread 301 represent a basic block which performs an operation equivalent to an execution path that is taken in the thread 300 when the transition is made from I, J, and then Q in this order. Similarly, the basic blocks I, J, K, and S in the thread 302 and the basic blocks I, J, K, and L in the thread 303 represent basic blocks, respectively.

Then, optimization is performed for each of the extracted threads to reduce an execution time per thread, and then the threads 300, 301, 302, and 303 are executed in parallel. As a result, as compared to the case where the thread 300 which is the program part before conversion is solely executed, the execution time can be reduced.

### SUMMARY OF THE INVENTION

The present invention is based on the concept of Patent Reference 1 and has an object to provide a program conversion apparatus which is more practical and more functionally-extended and which is designed for a computer system with a shared-memory multiprocessor architecture. To be more specific, the object of the present invention is to provide the program conversion apparatus which is designed for a shared-memory multiprocessor computer system having a processor capable of executing instructions in parallel, and which achieves: thread generation such that the generated threads do not contend for access to a shared memory; thread generation using a value held by a variable in an execution path; instruction generation for thread execution control; and scheduling of the instructions in the thread.

It should be noted that since a memory is represented by a variable in a program, a shared memory is also represented by a shared variable.

In order to achieve the aforementioned object, the program conversion apparatus according to an aspect of the present invention is a program conversion apparatus including: a thread creation unit which creates a plurality of threads equivalent to a program part included in a program, based on path information on a plurality of execution paths, each of the execution paths going from a start to an end of the program part, each of the threads being equivalent to at least one of the execution paths; a replacement unit which performs variable replacement on the threads so that a variable shared by the threads is accessed by only one of the threads in order to avoid an access conflict among the threads; and a thread parallelization unit which generates a program that causes the threads to be speculatively executed in parallel after the variable replacement.

With this configuration, the specific part of the program is executed by the plurality of threads which are executed in parallel, so that the execution time of the specific part of the program can be reduced.

Also, the thread creation unit may include: a main block generation unit which generates a thread main block that is a main body of a thread, by copying an instruction included in one of the execution paths of the program part; and an other-thread stop block generation unit which generates an other-thread stop block including an instruction for stopping an execution of an other thread and arranges the other-thread stop block after the thread main block, and the replacement unit may include: an entry-exit variable detection unit which detects an entry live variable and an exit live variable that are live at a beginning and an end of the thread main block, respectively; an entry-exit variable replacement unit which generates a new variable for each of the detected entry and exit live variables, and replaces the detected live variable with the new variable in the thread main block; an entry block generation unit which generates an entry block including an instruction for assigning a value held by the detected entry live variable to the new variable generated by the entry-exit variable replacement unit and arranges the entry block before the thread main block; an exit block generation unit which generates an exit block including an instruction for assigning a value held by the new variable generated by the entry-exit variable replacement unit to the detected exit live variable and arranges the exit block after the other-thread stop block; a thread variable detection unit which detects a thread live variable that is not detected by the entry-exit variable detection unit and that occurs in the thread main block; and a thread variable replacement unit which generates a new variable for the detected thread live variable and replaces the detected thread live variable with the new variable in the thread main block.

With this configuration, the variable shared by the threads can be accessed by only one thread. More specifically, a variable to which a write operation is to be performed within the thread main block is replaced with a newly generated variable and, after an other thread is stopped, the write operation is executed on the variable shared by the Is threads. In addition, when the write operation is performed on the shared variable, the operation is performed only on the variable live at the exit of the thread. This can prevent a needless write operation from being performed.

Moreover, the thread creation unit may further include a self-thread stop instruction generation unit which, when a branch target instruction of a conditional branch instruction in the thread main block does not exist in the execution path of the thread main block, generates a self-thread stop instruction, as the branch target instruction, in order to stop the thread, and arranges the self-thread stop instruction in the thread main block.

With this configuration, when it is determined that the present thread should not be executed in the first place, the present thread can be stopped and the right to use the processor can be given to a different thread.

Furthermore, when the branch target instruction of the conditional branch instruction which branches when a determination condition is not satisfied does not exist in the execution path of the thread main block, the self-thread stop instruction generation unit may further: reverse the determination condition of the conditional branch instruction; generate a self-thread stop instruction, as the branch target instruction, in order to stop the thread for a case where the reversed determination condition is satisfied; and arrange the self-thread stop instruction in the thread main block.

With this configuration, when an instruction of a branch destination of the case where a determination condition of a conditional branch instruction in a thread is not satisfied does not exist within the present thread, the present thread can be stopped and the right to use the processor can be given to a different thread.

Also, the program conversion apparatus may further include a to thread optimization unit which optimizes the instructions in the threads on which the variable replacement has been performed by the replacement unit, so that the instructions are executed more efficiently, wherein the thread parallelization unit may generate a program that causes the threads optimized by the thread optimization unit to be speculatively executed in parallel.

With this configuration, the thread is optimized and can be thus executed in a short time.

Moreover, the thread optimization unit may include an entry block optimization unit which performs optimizations of copy propagation and dead code elimination on: the instruction of the entry block in the thread on which the variable replacement has been performed; the thread main block; and the exit block.

With this configuration, a needless instruction, which occurs when conversion is performed so that a write operation to the variable shared by the threads is performed by a single thread, can be deleted.

Furthermore, the thread optimization unit may further include: a general dependency calculation unit which calculates a dependency relation among the instructions of the threads on which the variable replacement has been performed by the replacement unit, based on a sequence of updates and references performed on the instructions in the threads; a special dependency generation unit which generates a dependency relation such that the instruction in the other-thread stop block is executed before the instruction in the exit block is executed and a dependency relation such that the self-thread stop instruction is executed before the instruction in the other-thread stop block is executed; and an instruction scheduling unit which parallelizes the instructions in the threads, according to the dependency relation calculated by the general dependency calculation unit and the dependency relations generated by the special dependency generation unit.

With this configuration, the instructions having no dependence on the execution sequence, among the instructions in the thread, can be executed in parallel, instead of being executed simply in order from the entry to the exit. Thus, the thread can be executed in a short time.

Also, the path information may include a variable existing in the execution path and a constant value predetermined for the variable, the program conversion apparatus may further include: a constant determination block generation unit which generates a constant Is determination block and arranges the constant determination block before the entry block, the constant determination block including: an instruction for determining whether a value of the variable is equivalent to the constant value; and an instruction for stopping the thread when the value of the variable is not equivalent to the constant value; and a constant conversion unit which converts the variable in the thread main block into the constant value, and the thread parallelization unit may generate a program that causes the threads to be speculatively executed in parallel after the conversion.

With this configuration, when a value held by a variable in a specific thread is constant, optimization using this value can be performed on the thread. Thus, the thread can be executed in a short time.

Moreover, the special dependency generation unit may further generate a special dependency relation such that the instructions in the constant determination block are executed before the instruction in the other-thread stop block is executed.

With this configuration, when a value held by a variable in a specific thread is constant and the optimization using this value has been performed on the thread, the instructions having no dependence on the execution sequence, among the instructions in the thread, can be executed in parallel. Thus, the thread can be executed in a short time.

Furthermore, the threads may include a first thread and a second thread, and the main block generation unit may include: a path relation calculation unit which calculates a path inclusion relation between the first and second threads; and a main block simplification unit which deletes, from the first thread, a path included in both the first and second threads, when it is determined from the path inclusion relation that the first thread includes the second thread.

With this configuration, a path which is not to be executed within the thread is deleted. Accordingly, the number of instructions in the thread is reduced and the code size of the thread is also reduced. Also, the deletion of the to-be-unexecuted path increases the number of occasions where new optimization can be performed, thereby increasing the number of occasions where the thread can be executed in a short time.

Also, the thread parallelization unit may include: a thread relation calculation unit which determines whether an execution path equivalent to a first thread is included in an execution path equivalent to a second thread, the first and second threads being included in the threads and calculates a thread inclusion relation between the first and second threads by determining that the first thread is included in the second thread when determining that the execution path equivalent to the first thread is included in the execution path equivalent to the second thread; a thread execution time calculation unit which calculates an average execution time for each of the generated threads, using the path information including a path execution probability and a value probability that a variable holds a specific value; and a thread deletion unit which deletes the first thread, when the first thread is included in the second thread and the average execution time of the second thread is shorter than the average execution time of the first thread.

With this configuration, a thread which is useless even when executed can be deleted using the average execution time of the thread. Thus, the code size is prevented from increasing, and the processor is not allowed to perform the useless thread. This can increase the number of occasions where other threads can use the processor.

Moreover, the program may include path identification information for identifying a path included in the program part, and the program conversion apparatus may further include a path analysis unit which analyzes the path identification information and extracts the path information.

With this configuration, the user of the program conversion apparatus can describe the path identification information directly in the source program so as to designate the program part which the user wishes to thread. Thus, efficiency of the program can be increased by the user in a short time.

Furthermore, the program may include variable information indicating a value held by a variable existing in the execution path, and the path analysis unit may include a variable analysis unit which determines the value held by the variable, by analyzing the path identification information and the variable information.

With this configuration, the user of the program conversion apparatus can describe a value held by a variable which is live in the path directly into the source program, so that the thread can be executed in a shorter time. Thus, efficiency of the program can be increased by the user in a short time.

Also, the program may include: path identification information for identifying a path; execution probability information on the path; variable information indicating a value held by the variable existing in the path; and value probability information indicating a probability that the variable holds the specific value, and the program conversion apparatus may further include a probability determination unit which determines the path execution probability and the value probability, according to the path identification information, the execution probability information, the variable information, and the value probability information.

With this configuration, the user of the program conversion apparatus can describe the execution probability information of the path and the value probability information indicating a probability that a variable in the path holds a specific value, directly in the source program. As a result of this, on the basis of the average execution time of threads, generation of useless threads is prevented and, thus, a thread can be generated efficiently. Thus, efficiency of the program can be increased by the user in a short time.

The present invention is implemented not only as the program conversion apparatus described above, but also as a program conversion method having, as steps, the processing units included in the program conversion apparatus and as a program causing a computer to execute such characteristic steps. In addition, it should be obvious that such a program can be distributed via a computer-readable recording medium such as a CD-ROM or via a communication medium such as the Internet.

The program conversion apparatus according to the present invention can convert a specific part of the program into a program whereby a plurality of threads are speculatively executed in parallel and, thus, the specific part of the program can be executed in a short time.

### FURTHER INFORMATION ABOUT TECHNICAL BACKGROUND TO THIS APPLICATION

The disclosure of Japanese Patent Application No. 2008-198375 filed on Jul. 31, 2008 including specification, drawings and claims is incorporated herein by reference in its entirety.

The disclosure of PCT application No. PCT/JP2009/001932 filed on Apr. 28, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing an example of an overview of a computer system.

FIG. 2 is a block diagram showing a configuration of a compiler system.

FIG. 3 is a diagram showing a hierarchical configuration of a program conversion apparatus.

FIG. 4 is a diagram showing an example of a source program.

FIG. 5 is a diagram showing an example of a source program in which path identification information is described.

FIG. 6 is a diagram showing an example of a program including a thread main block.

FIG. 7 is a diagram showing an example of a program including a thread having a self-thread stop instruction.

FIG. 8 is a diagram showing an example of a program including a thread having an other-thread stop block.

FIG. 9 is a diagram showing an example of a program including a thread having an entry block and an exit block.

FIG. 10 is a diagram showing an example of a program including a thread having live variables.

FIG. 11 is a diagram showing an example of a program including a thread on which copy propagation and dead code elimination have been performed.

FIG. 12 is a graph showing an example of a general dependency relation.

FIG. 13 is a graph showing an example where a special dependency relation is added.

FIG. 14 is a diagram showing an example of a program including a thread on which instruction scheduling has been performed.

FIG. 15 is a diagram showing an example of a program including a thread having a thread main block and an other-thread stop block which are obtained by threading the source program.

FIG. 16 is a diagram showing another example of a program including a thread having an entry block and an exit block.

FIG. 17 is a diagram showing another example of a program including a thread having live variables.

FIG. 18 is a diagram showing another example of a program including a thread on which copy propagation and dead code elimination have been performed.

FIG. 19 is a diagram showing an example of a program including parallelized threads.

FIG. 20 is a diagram showing a hierarchical configuration of a program conversion apparatus in a first modification.

FIG. 21 is a diagram showing an example of a source program in which variable information is described, according to the first modification.

FIG. 22 is a diagram showing an example of a program including a thread on which copy propagation and dead code elimination have been performed, according to the first modification.

FIG. 23 is a diagram showing an example of a program including a thread having a constant determination block, according to the first modification.

FIG. 24 is a diagram showing an example of a program including a thread on which constant propagation and constant folding have been performed, according to the first modification.

FIG. 25 is a diagram showing an example of a program including a thread from which unnecessary instructions and unnecessary branches have been deleted, according to the first modification.

FIG. 26 is a graph showing an example where a special dependency relation is added, according to the first modification.

FIG. 27 is a diagram showing an example of a program including a thread on which instruction scheduling has been performed, according to the first modification.

FIG. 28 is a diagram showing an example of a program including parallelized threads, according to the first modification.

FIG. 29 is a diagram showing an example of a program including a source program in which a plurality of path information pieces are described, according to a second modification.

FIG. 30 is a diagram showing a hierarchical configuration of a main block generation unit, according to the second modification.

FIG. 31A is a diagram showing an example of a program including a thread main block, according to the second modification.

FIG. 31B is a diagram showing an example of a program including a thread on which each of the processes has been performed, according to the second modification.

FIG. 32 is a diagram showing an example of a program including parallelized threads, according to the second modification.

FIG. 33 is a diagram showing another example of a program including parallelized threads, according to the second modification.

FIG. 34 is a diagram showing an example of a source program in which probability information is described, according to a third to modification.

FIG. 35 is a diagram of a program showing a part of an example of parallelized threads, according to the third modification.

FIG. 36 is a diagram of a program showing a part of another example of parallelized threads, according to the third modification.

FIG. 37 is a diagram showing a hierarchical configuration of a thread parallelization unit, according to the third modification.

FIG. 38 is a diagram explaining a conventional technology.

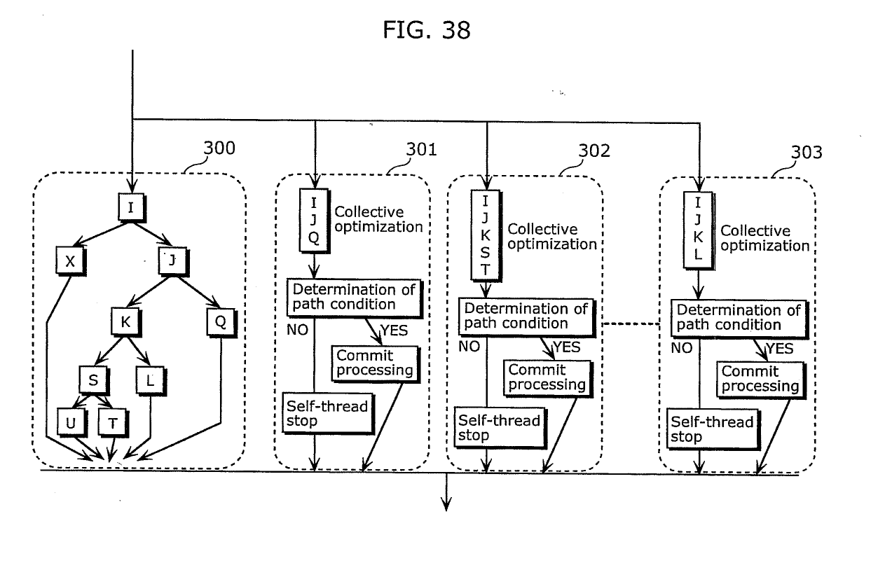

The following is a description of an embodiment of, for example, a program conversion apparatus, with reference to the drawings. It should be noted that the components with the same reference numeral perform the identical operation and, therefore, their explanations may not be repeated.

### <Explanation of Terms>

Before a specific embodiment is described, terms used in the present specification are defined as follows.

Statement

A “statement” refers to an element of a typical programming language. Examples of the statement include an assignment statement, a branch statement, and a loop statement. Unless otherwise specified, a “statement” and an “instruction” are used as synonyms in the present embodiment.

Path

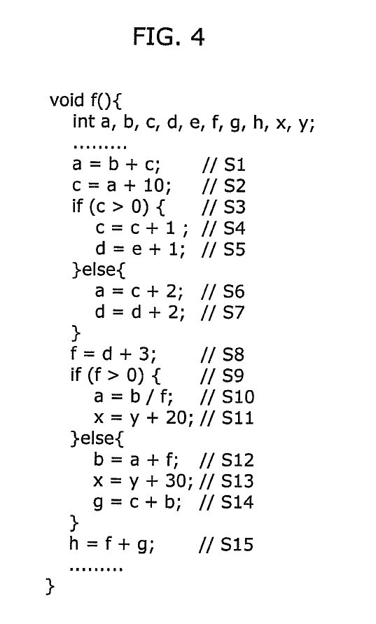

A “path” is formed from a plurality of statements among which the execution sequence is usually defined. Note that the execution sequence of some statements forming the path may not be defined. For example, when the execution sequence of the program shown in FIG. 4 is represented by an arrow “( )”, the following sequence can be considered as one path:

S1 ( ) S2 ( ) S3 ( ) S4 ( ) S5 ( ) S8 ( ) S9 ( ) S12 ( ) S13 ( ) S14 ( ) S15.

Also, the sequence combining the following two can be considered as one path:

S1 ( ) S2 ( ) S3 ( ) S4 ( ) S5 ( ) S8 ( ) S9 ( ) S12 ( ) S13 ( ) S14 ( ) S15; and

S1 ( ) S2 ( ) S3 ( ) S6 ( ) S7 ( ) S8 ( ) S9 ( ) S12 ( ) S13 ( ) S14 ( ) S15. In this case, the execution sequence is not defined between S4 and the two of S6 and S7, and between S5 and the two of S6 and S7.

Thread

A “thread” is a sequence of ordered instructions suitable for processing by a computer.

### DESCRIPTION OF THE PREFERRED EMBODIMENT

### Preferred Embodiment

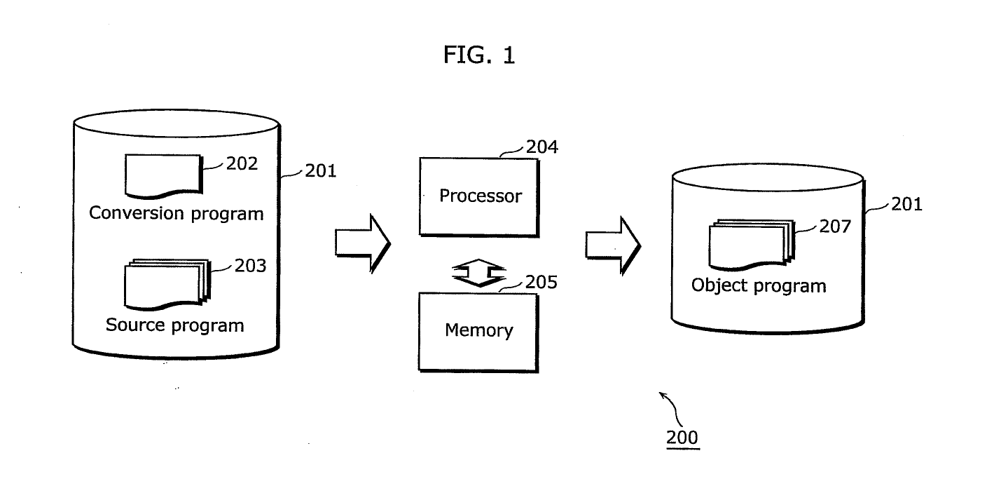

A program conversion apparatus in the embodiment according to the present invention is implemented on a computer system 200. FIG. 1 is a diagram showing an example of an overview of the computer system 200. A storage unit 201 is a large capacity storage such as a hard disk. A processor 204 includes a control unit and an arithmetic unit. A memory 205 is configured with a memory element such as a metal oxide semiconductor integrated circuit (MOS-IC).

The program conversion apparatus in the embodiment according to the present invention is implemented as a conversion program 202 in the storage unit 201. The conversion program 202 is stored in the memory 205 by the processor 204, and is executed by the processor 204. Following the instructions in the conversion program 202, the processor 204 converts a source program 203 stored in the storage unit 201 into an object program 207 using a compiler system 210 described later, and then stores the object program 207 into the storage unit 201.

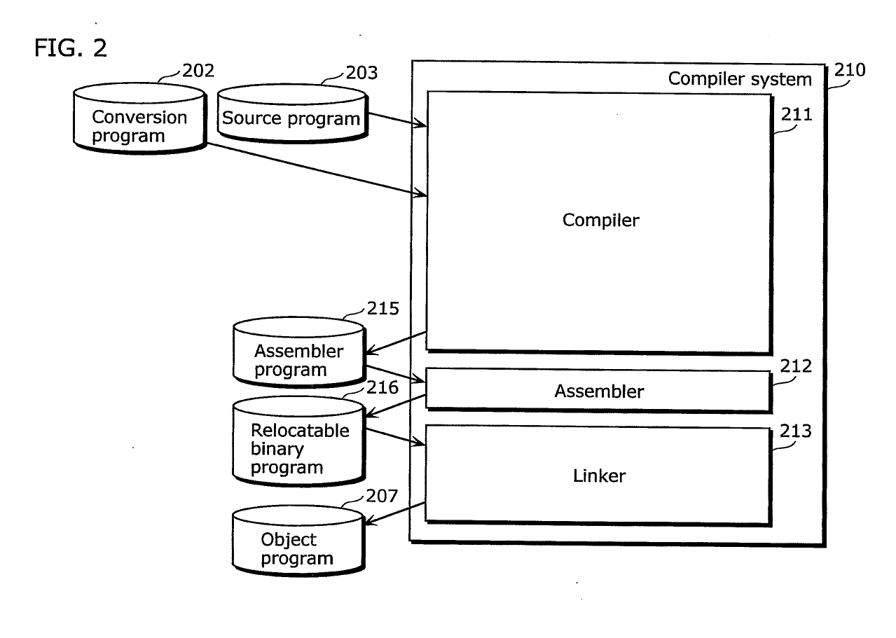

FIG. 2 is a block diagram showing a configuration of the compiler system 210 included in the processor 204. The compiler system 210 converts the source program 203 described in a high-level language, such as C or C++, into the object program 207 which is a machine language program. The compiler system 210 is roughly configured with a compiler 211, an assembler 212, and a linker 213.

The compiler 211 generates an assembler program 215, by compiling the source program 203 and replacing the source program to 203 with machine language instructions according to the conversion program 202.

The assembler 212 generates a relocatable binary program 216, by replacing all codes of the assembler program 215 provided by the compiler 211 with binary machine language codes with reference to a conversion table or the like that is internally held.

The linker 213 generates the object program 207, by determining an address arrangement or the like of unresolved data of a plurality of relocatable binary programs 216 provided by the assembler 212 and combining the addresses.

Next, the program conversion apparatus implemented as the above-described conversion program 202 is explained in detail. The program conversion apparatus in the present embodiment is Claim 1 copy

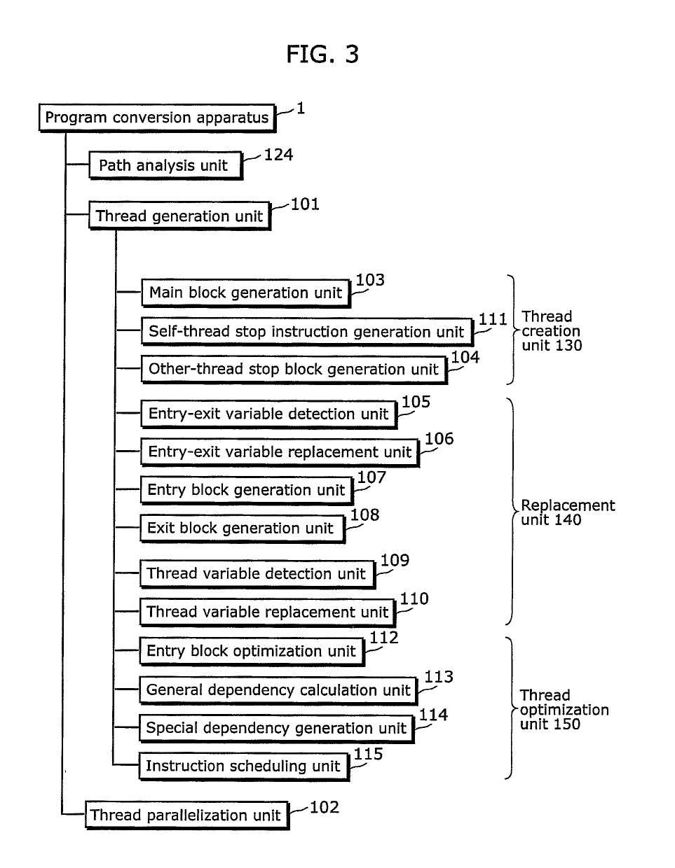

FIG. 3 is a diagram showing a hierarchical configuration of a program conversion apparatus.

A program conversion apparatus 1 includes a path analysis unit 124, a thread generation unit 101, and a thread parallelization unit 102. To be more specific, the thread generation unit 101 has a main block generation unit 103, a self-thread stop instruction generation unit 111, an other-thread stop block generation unit 104, an entry-exit variable detection unit 105, an entry-exit variable replacement unit 106, an entry block generation unit 107, an exit block generation unit 108, a thread variable detection unit 109, a thread variable replacement unit 110, an entry block optimization unit 112, a general dependency calculation unit 113, a special dependency generation unit 114, and an instruction scheduling unit 115.

Here, the main block generation unit 103, the self-thread stop instruction generation unit 111, and the other-thread stop block generation unit 104 configure a thread creation unit 130. Also, the entry-exit variable detection unit 105, the entry-exit variable replacement unit 106, the entry block generation unit 107, the exit block generation unit 108, the thread variable detection unit 109, and the thread variable replacement unit 110 configure a replacement unit 140. Moreover, the entry block optimization unit 112, the general dependency calculation unit 113, the special dependency generation unit 114, and the instruction scheduling unit 115 configure a thread optimization unit 150.

FIG. 3 also shows an order of operations performed by the program conversion apparatus 1, that is, the units are activated in order from the top. More specifically, the program conversion apparatus 1 activates the path analysis unit 124, the thread generation unit 101, and the thread parallelization unit 102 in this order. The thread generation unit 101 activates the main block generation unit 103, the self-thread stop instruction generation unit 111, and an other-thread stop block generation unit 104, the entry-exit variable detection unit 105, the entry-exit variable replacement unit 106, the entry block generation unit 107, the exit block generation unit 108, the thread variable detection unit 109, the thread variable replacement unit 110, the entry block optimization unit 112, the general dependency calculation unit 113, the special dependency generation unit 114, and the instruction scheduling unit 115, in this order.

The above units are explained as follows in the order in which these units are activated. Also, specific operations are described based on examples shown in FIGS. 4 to 19.

The path analysis unit 124 extracts path information by analyzing path identification information, which identifies a path, described in a source program by a programmer.

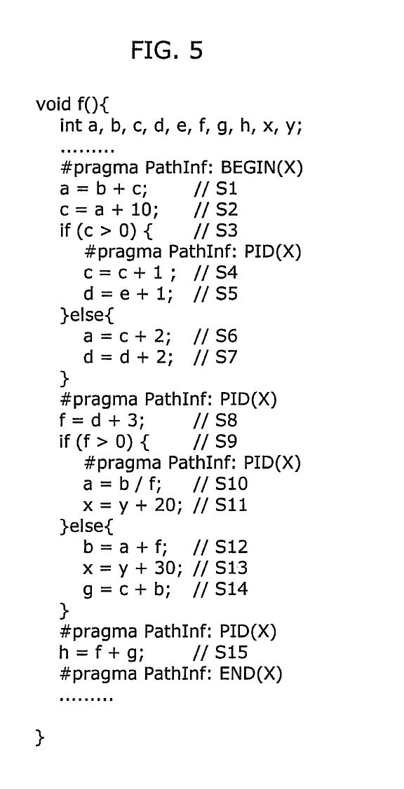

FIG. 4 is a diagram showing an example of a source program described according to the C language notation. FIG. 5 is a diagram showing an example of a source program in which the path identification information is additionally described. In FIG. 5, “#pragma PathInf” indicates various kinds of path information. More specifically: “#pragma PathInf: BEGIN(X)” indicates the beginning of the path; “#pragma PathInf: END(X)” indicates the end of the path; and “#pragma PathInf: PID(X)” indicates a midpoint of the path. Here, “X” represents a path name identifying the path. By following along these three kinds of path information in the execution sequence indicated by the program, the path is determined. To be more specific, the path X in FIG. 5 is determined as:

S1 ( ) S2 ( ) S3 ( ) S4 ( ) S5 ( ) S8 ( ) S9 ( ) S10 ( ) S11 ( ) S15.

Also, in the case where “#pragma PathInf: PID(X)” immediately after S9 in FIG. 5 does not exist, the path X is determined as a combination of the following two:

S1 ( ) S2 ( ) S3 ( ) S4 ( ) S5 ( ) S8 ( ) S9 ( ) S10 ( ) S11 ( ) S15; and

S1 ( ) S2 ( ) S3 ( ) S4 ( ) S5 ( ) S8 ( ) S9 ( ) S12 ( ) S13 ( ) S14 ( ) S15.

The thread generation unit 101 generates a plurality of threads from the path information on the specific part of the program, so as to avoid a race condition where the threads contend for access to a storage area such as a memory or register. To be more specific, the thread generation unit 101 has the main block generation unit 103, the self-thread stop instruction generation unit 111, the other-thread stop block generation unit 104, the entry-exit variable detection unit 105, the entry-exit variable replacement unit 106, the entry block generation unit 107, the exit block generation unit 108, the thread variable detection unit 109, the thread variable replacement unit 110, the entry block optimization unit 112, the general dependency calculation unit 113, the special dependency generation unit 114, and the instruction scheduling unit 115, as shown in FIG. 3.

The main block generation unit 103 generates a thread main block by copying the path from the path information.

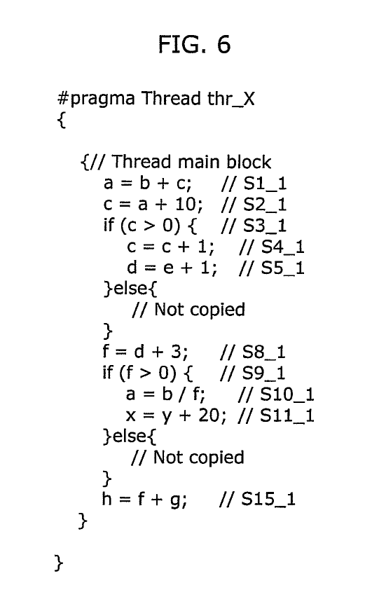

FIG. 6 is a diagram showing a program including a thread main block generated by copying the path X shown in FIG. 5. In the present embodiment, a thread is defined by “#pragma Thread thr_X” and subsequent curly brackets “{ }” as shown in FIG. 6. Here, “thr_X” represents a thread name identifying the thread and, hereafter, the thread is identified by its name, such as “thread thr_X”. Also, the range of the thread main block is specified using the curly brackets like “{// Thread main block . . . }” as shown in FIG. 6. Thus, the above description may be summarized as follows: the main block generation unit 103 generates the thread main block of the thread thr_X by copying the path X shown in FIG. 5, that is, S1 ( ) S2 ( ) S3 ( ) S4 ( ) S5 ( ) S8 ( ) S9 ( ) S10 ( ) S11 ( ) S15. In particular, when a conditional branch instruction S3 or S9 is not taken, the corresponding “else” side in the execution path is not copied.

When a determination condition of the conditional branch instruction in the thread main block is satisfied and a branch destination is not copied in the thread main block, the self-thread stop instruction generation unit 111 generates a self-thread stop instruction in order to stop the self-thread for the case where the determination condition is satisfied. When the determination condition of the conditional branch instruction in the thread main block is not satisfied and a branch destination is not copied in the thread main block, the self-thread stop instruction generation unit 111 reverses the determination condition and generates a self-thread stop instruction in order to stop the self-thread for the case where the reversed determination condition is satisfied.

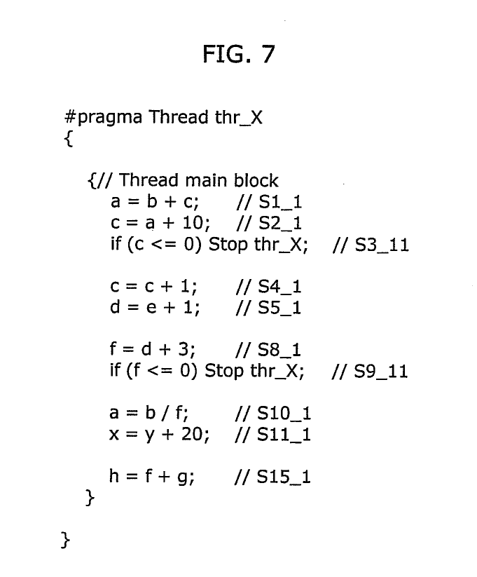

FIG. 7 shows a result of processing performed on the thread thr_X shown in FIG. 6 by the self-thread stop instruction generation unit 111. As can be determined from the source program shown in FIG. 5, a statement obtained by copying the statement S6 which is the branch destination in the case where the conditional branch instruction S3 is not taken does not exist in the thread main block of the thread thr_X. Thus, the self-thread stop instruction generation unit 111 reverses the determination condition into S3_11 and generates an instruction represented as “Stop thr_X” in order to stop the self-thread in the case where the reversed determination condition is satisfied. The determination condition of “S9_11” can be explained similarly.

The other-thread stop block generation unit 104 generates an other-thread stop block including an instruction to stop the execution of an other thread, and arranges the generated block after the end of the thread main block.

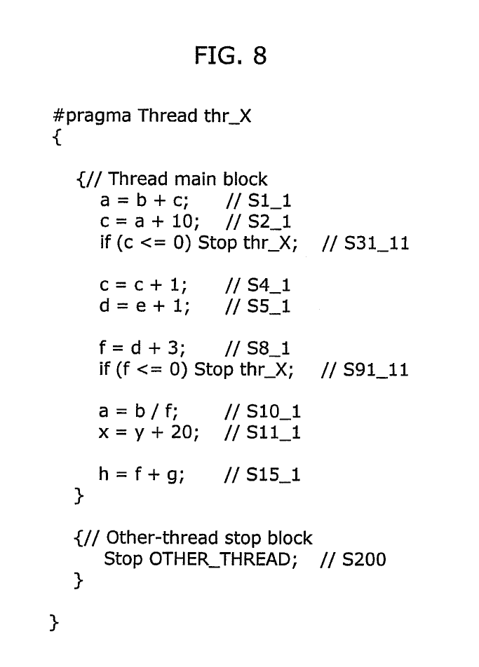

FIG. 8 shows a result of processing performed on the thread thr_X shown in FIG. 7 by the other-thread stop block generation unit 104. The other-thread stop block is generated after the end of the thread main block. In this diagram, “Stop OTHER_THREAD” indicates that an other thread executed in parallel with the thread thr_X is stopped. Once the identification name of this other thread is determined, a specific thread name is described as “OTHER_THREAD”. This is described in detail later

The entry-exit variable detection unit 105 detects a variable which is live at the entry and exit of the thread main block.

The definition of a live variable and the method of calculating the live variable are the same as those described by A. V. Aho, R. Sethi, and J. D. Ullman in “Compilers: Principle, Techniques, and Tool”, Addison Wesley Publishing Company Inc., 1986, pp. 631 to 632 (referred to as Non-Patent Reference 1 hereafter). These definition and method are not principal objectives of the present invention and thus are not explained here. A variable which is “live” at the entry of the thread main block refers to a variable that is not updated before being referenced, and such a variable is referred to as the “entry live variable” hereafter. Also, a variable which is “live” at the exit of the thread main block refers to a variable that is referenced after the execution of the thread main block, and such a variable is referred to as the “exit live variable” hereafter. More specifically, the exit live variable refers to a variable referenced after “#pragma PathInf: END ( . . . )”, which indicates the end of the path in the source program where the path identification information is described, is designated. That is, the exit live variable is referenced after the statement S15 in FIG. 5. In the case of the thread main block shown in FIG. 8, the entry-exit variable detection unit 105 detects variables b, c, e, g and y as the entry live variables, and also detects variables a, c, h, and x as the exit live variables.

Next, the entry-exit variable replacement unit 106 generates a new variable for each of the entry and exit live variables and replaces the entry or exit live variable with the newly generated variable at a position of its occurrence in the thread main block. Each of the entry block generation unit 107 and the exit block generation unit 108 generates an instruction to exchange the values between the entry or exit live variable and the newly generated variable.

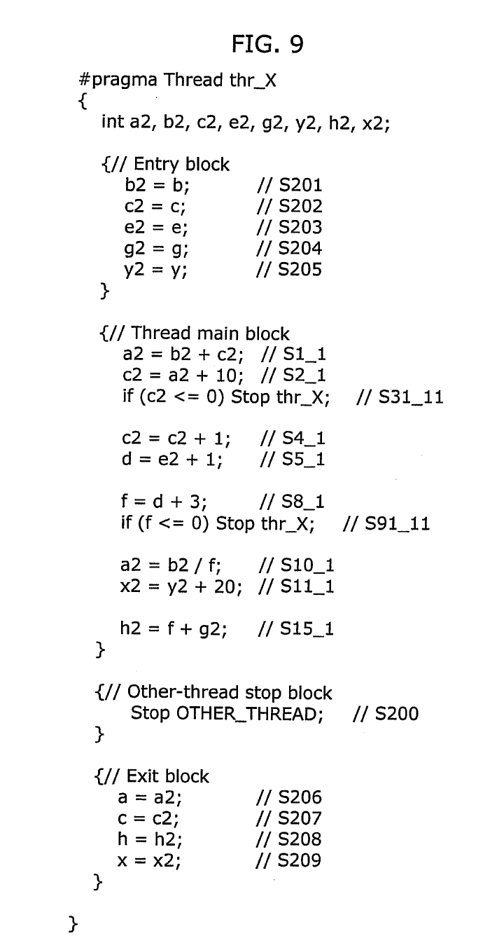

FIG. 9 shows a result of processing performed on the thread main block shown in FIG. 8 by the entry-exit variable replacement unit 106, the entry block generation unit 107, and the exit block generation unit 108.

For example, the variable b, which is an entry live variable in the thread main block shown in FIG. 8, is replaced with a newly generated variable b2 at every position of its occurrence in the thread main block shown in FIG. 9. The other entry live variables c, e, g, and y are replaced similarly. Also, the variable a, which is an exit live variable in the thread main block shown in FIG. 8, is replaced with a newly generated variable a2 at every position of its occurrence in the thread main block shown in FIG. 9. The other exit live variables c, h, and x are replaced similarly. It should be noted here that since the variable c is an entry live variable as well and thus has been replaced with a variable c2, the replacement as the exit live variable is omitted.

The entry block generation unit 107 generates an entry block formed from a set of instructions to assign the values held by the entry live variables to the corresponding variables newly generated by the entry-exit variable replacement unit 106, and then arranges the generated entry block before the beginning of the thread main block.

The exit block generation unit 108 generates an exit block formed from a set of instructions to assign the values held by the variables generated by the entry-exit variable replacement unit 106 to the corresponding exit live variables, and then arranges the generated exit block after the end of the other-thread stop block.

The entry and exit blocks shown in FIG. 9 are the results of processing performed on the thread main block and the other-thread stop block shown in FIG. 9 by the entry block generation unit 107 and the exit block generation unit 108, respectively.

For example, in the entry block shown in FIG. 9, a statement S201 is generated. By the statement 201, the value held by the variable b which is live at the entry of the thread main block shown in FIG. 8 is assigned to the variable b2 generated by the entry-exit variable replacement unit 106. Similarly, value assignments are performed corresponding to the other entry live variables c, e, g, and y.

Also, in the exit block shown in FIG. 9, a statement S206 is generated. By the statement 206, the value held by the variable a2 generated by the entry-exit variable replacement unit 106 is assigned to the variable a which is live at the exit of the thread main block shown in FIG. 8. Similarly, value assignments are performed corresponding to the other exit live variables c, h, and x.

Next, a variable which is not detected by the entry-exit variable detection unit 105 and which occurs in the thread main block is detected and accordingly replaced.

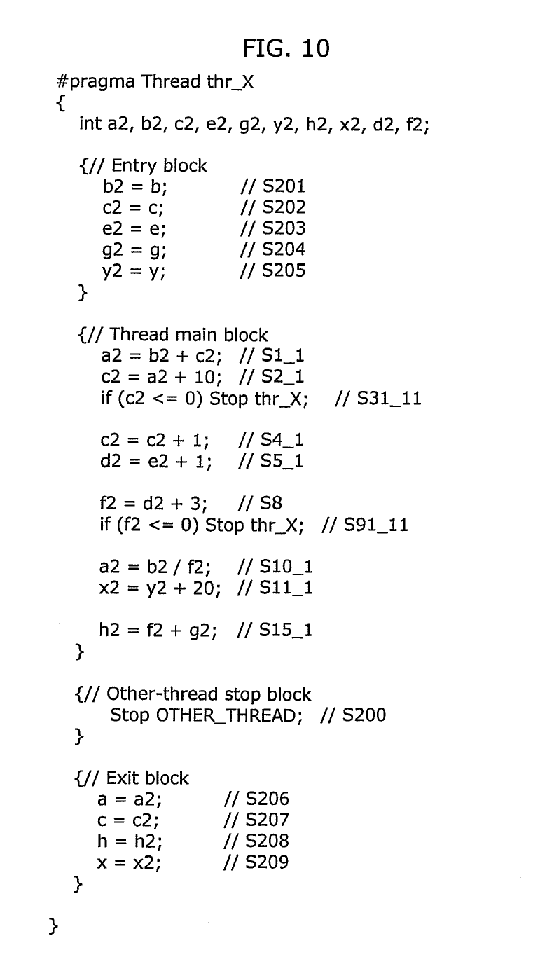

FIG. 10 shows a result of processing performed on the thread main block shown in FIG. 9 by the thread variable detection unit 109 and the thread variable replacement unit 110.

The thread variable detection unit 109 detects a thread live variable which is not detected by the entry-exit variable detection unit 105 and which occurs in the thread main block. In the case shown in FIG. 9, the variables d and f which have not been detected by the entry-exit variable detection unit 105 are detected.

The thread variable replacement unit 110 generates a new variable for each of the detected thread live variables and replaces the thread live variable with the newly generated variable at a position of its occurrence in the thread main block. In the thread main block shown in FIG. 9, the variable d is replaced with a newly generated variable d2 as shown in FIG. 10. Similarly, the variable f is replaced with a variable f2.

Here, FIG. 8 showing the thread thr_X obtained through the conversion performed by the units up to the other-thread stop block generation unit 104 is compared to FIG. 10 showing the thread thr_X obtained through the processing performed by the units up to the thread variable replacement unit 110. The respective numbers of entry live variables and exit live variables in FIG. 8 are the same as those in FIG. 10. Also, although the variables stored in the respective thread main blocks are different, the calculation processes are completely the same between FIG. 8 and FIG. 10. In other words, the thread thr_X shown in FIG. 8 is identical to the one shown in FIG. 10.

The explanation about the processing units is continued as follows.

The entry block optimization unit 112 performs copy propagation on the instructions included in the entry block to propagate them into the thread main block and the exit block, and also performs dead code elimination on these instructions.

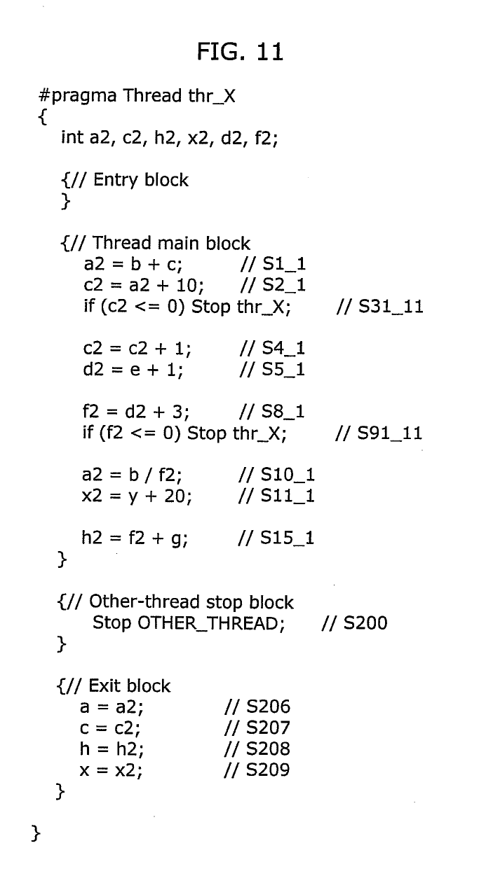

FIG. 11 shows a result of the copy propagation and dead code elimination performed on the thread shown in FIG. 10.

The methods of copy propagation and dead code elimination are the same as those described by A. V. Aho, R. Sethi, and J. D. Ullman in “Compilers: Principle, Techniques, and Tool”, Addison Wesley Publishing Company Inc., 1986, pp. 594 to 595 and pp. 636 to 638 (referred to as Non-Patent Reference 2 hereafter). These methods are not principal objectives of the present invention and thus are not explained here. Instead, specific examples are described with reference to FIGS. 10 and 11.

Copy propagation is performed by replacing the variable b2 with the variable b having a value equivalent to the value held by the variable b2, in the statements S1_1 and S10_1 which are reference destinations of the variable b2 set in the statement S201 in FIG. 10. As a result, a2=b+c and a2=b/f2, as shown in FIG. 11. Moreover, since a statement to reference to the value of the variable b2 set in the statement S201 does not exist in the thread main block and exist block, the statement S201 is considered as a dead code and thus deleted.

The other statements S202, S203, S204, and S205 in the entry block are also deleted after the variable conversion, as is the case with the statement S201.

The conversion processing by the units from the entry-exit variable detection unit 105 to the entry block optimization unit 112 described thus far is performed with the intention of avoiding a race condition between the self thread and the other thread which are executed in parallel and contend for access to a shared storage area such as a memory or register. For example, suppose that the program is executed as it is shown in FIG. 8, that is, the program without the processing performed by the entry-exit variable detection unit 105 is executed, and that the other thread references to the value of the variable a. In such a case, the value held by the variable a in the statement S1_1 is updated, which causes the other thread to perform unexpected processing. This ends up with a result different from the execution result of the source program shown in FIG. 5, meaning that a program different from the source program is generated.

As can be understood from the comparison between FIG. 8 and FIG. 11, the variable having a value to be updated in FIG. 8 is replaced with the newly generated variable in FIG. 11. Therefore, the execution up to the thread main block in FIG. 11 has no influence on the execution of the other thread. Also, before the exit block is executed, the other-thread stop block is executed in order to stop the other thread. Thus, a value held by the variable which is included in the statement of the exit block and which is shared by the threads can be safely updated. Here, the variable shared by the threads refers to the same single variable processed in the threads.

Next, in order to improve the processing speed for each thread, instruction levels in the thread are parallelized.

The general dependency calculation unit 113 calculates a general dependency relation among the instructions in the threads, based on a sequence of updates and references performed on the instructions in the threads. The general dependency calculation unit 113 is identical to the one described by Ikuo Nakata in “Compiler construction and optimization (in Japanese)”, Asakura Shoten, Sep. 20, 1999, pp. 412 to 414 (referred to as Non-Patent Reference 3 hereafter). This unit is not a principal objective of the present invention and thus is not explained here.

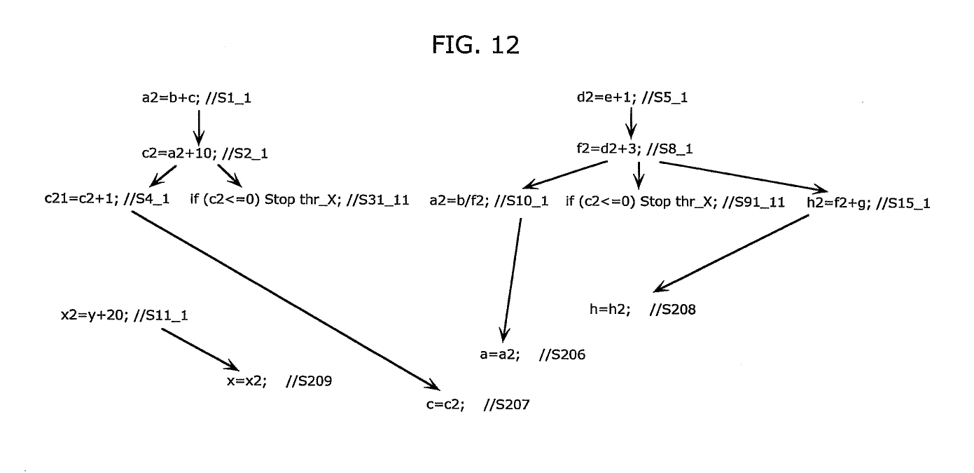

FIG. 12 shows a result of processing performed on the program shown in FIG. 11 by the general dependency calculation unit 113. That is, FIG. 12 is a graph showing a dependency relation among the statements. In this graph, a statement pointed by an arrow has a dependence on a statement from which the arrow originates. More specifically, “S2_1 ( ) S4_1” indicates that the statement S4_1 has a dependence on the statement S2_1 and that the statement S4_1 can be executed only after the statement S2_1 has been executed.

The special dependency generation unit 114 generates a special dependency relation such that the instruction in the other-thread stop block is executed before the instructions in the exit block are executed. Moreover, the special dependency generation unit 114 generates a special dependency relation such that the self-thread stop instruction is executed before the instruction in the other-thread stop block is executed.

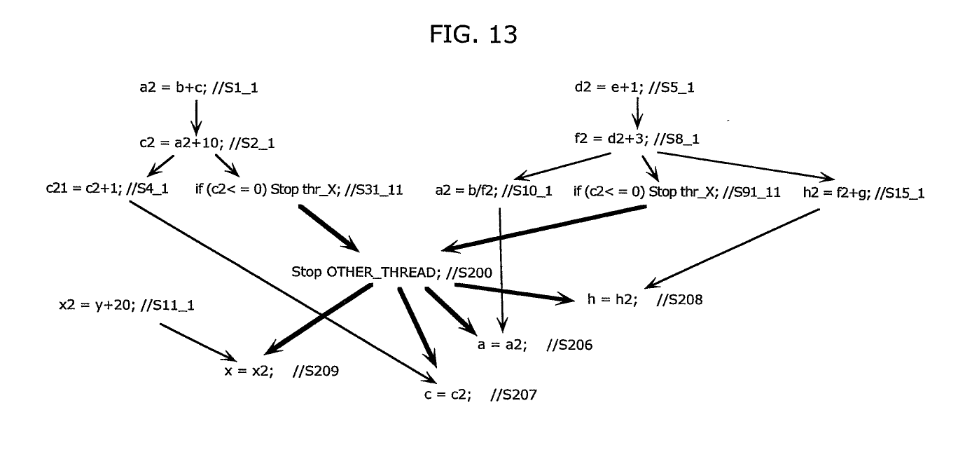

FIG. 13 shows a result of processing performed on the program shown in FIG. 11 by the special dependency generation unit 114. The dependencies generated by the special dependency generation unit 114, which are indicated by thick arrows, are added to the dependency graph of FIG. 12. With these generated dependencies, timing at which the other thread is stopped and an order in which the instructions in the exit block are executed can be properly designated.

The instruction scheduling unit 115 parallelizes the instructions of the threads, according to the dependency relation calculated by the general dependency calculation unit 113 and the dependency relation generated by the special dependency generation unit 114. The instruction scheduling unit 115 is identical to the one described by Ikuo Nakata in “Compiler construction and optimization (in Japanese)”, Asakura Shoten, Sep. 20, 1999, pp. 358 to 382 (referred to as Non-Patent Reference 4 hereafter). This unit is not a principal objective of the present invention and thus is not explained here.

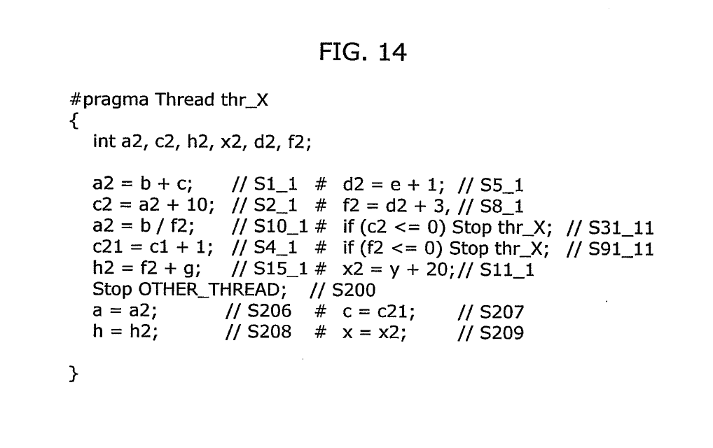

FIG. 14 shows a result of scheduling and parallelization performed on the instructions of the thread shown in FIG. 11 according to the dependency relation shown in FIG. 13. In this case here, suppose that two instructions can be executed in parallel. In FIG. 14, “#” represents a separator between the instructions which can be executed in parallel. For example, the statements S1_1 and S5_1 can be executed in parallel.

Up to this point, the thread generation relating to the path X in the source program shown in FIG. 5 has been explained. Here, it is obvious that the execution of only the thread thr_X shown in FIG. 14 is not equivalent to the execution of the source program shown in FIG. 5. This is because, in FIG. 5, the execution of the path X is only equivalent to the execution of one path from the statement S1 to the statement S15. Thus, suppose that a thread thr_Or is generated by threading the program part from the statement S1 to the statement S15 which is the source program in FIG. 5 and is executed in parallel with the thread thr_X in FIG. 14. In this case, even when the thread thr_X is stopped, the execution equivalent to the execution from the statement S1 to the statement S15 in FIG. 5 is definitely guaranteed by keeping the thread thr_Or from being stopped. The generation of the thread thr_Or is first explained as follows, and then the parallel execution of the threads thr_Or and thr_X is explained later.

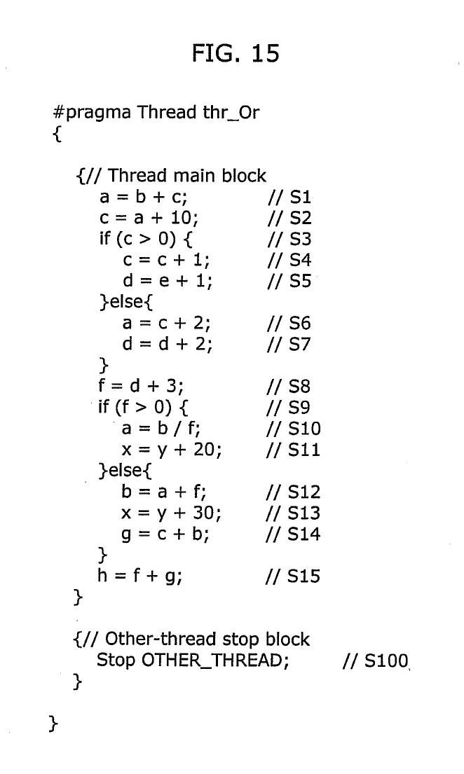

FIG. 15 is a diagram showing an example of a program including a thread main block and an other-thread stop block which are obtained by threading the source program shown in FIG. 5.

The thread thr_Or is generated in the same manner as the thread thr_X. As shown in FIG. 15, the main block generation unit 103 generates the thread main block of the thread thr_Or by copying all the paths from the statement S1 to the statement S15 in FIG. 5.

Next, the self-thread stop instruction generation unit 111 performs the processing while focusing on the branch destination for each conditional branch instruction in the thread main block in FIG. 15. Here, in each of the cases where the determination condition of the conditional branch instruction represented as the statement S3 is satisfied and unsatisfied, the corresponding branch destination is present in the thread main block. On this account, the instruction to stop the self thread is not generated. Similarly, for the conditional branch instruction represented as the statement S9, the instruction to stop the self thread is not generated for this same reason.

Then, as shown in FIG. 15, the other-thread stop block generation unit 104 generates the other-thread stop block and arranges this block after the end of the thread main block.

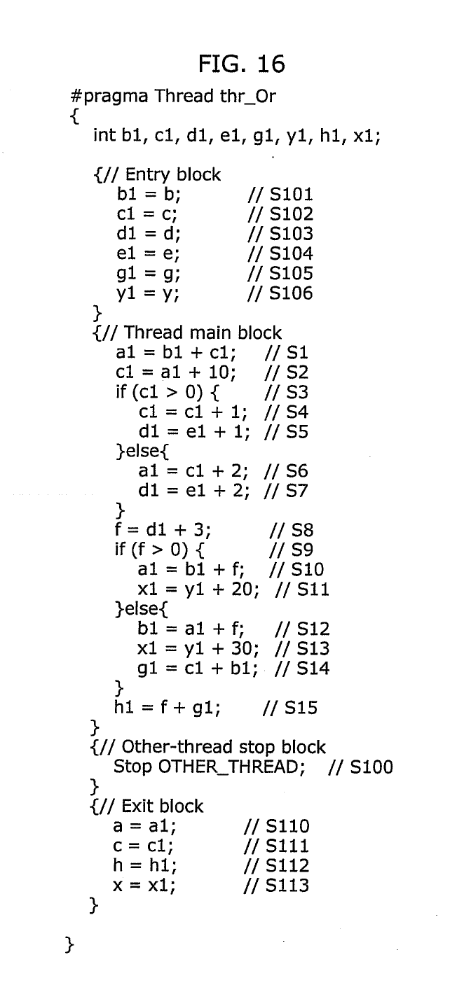

As is the case with the thread thr_X, the entry and exit live variables are detected and accordingly replaced. FIG. 16 shows a result of processing performed on the thread shown in FIG. 15 by the entry-exit variable detection unit 105, the entry-exit variable replacement unit 106, the entry block generation unit 107, and the to exit block generation unit 108.

The entry-exit variable detection unit 105 is activated to detect the variables b, c, d, e, g and y as the entry live variables and the variables a, c, h, and x as the exit live variables.

Next, the entry-exit variable replacement unit 106, the entry block generation unit 107, and the exit block generation unit 108 are activated. As a result of the processing performed by these units, the program shown in FIG. 15 is converted into a program shown in FIG. 16.

Then, as in the case with the thread thr_X, the thread variable detection unit 109 is activated to detect the variable f which has not been detected by the entry-exit variable detection unit 105.

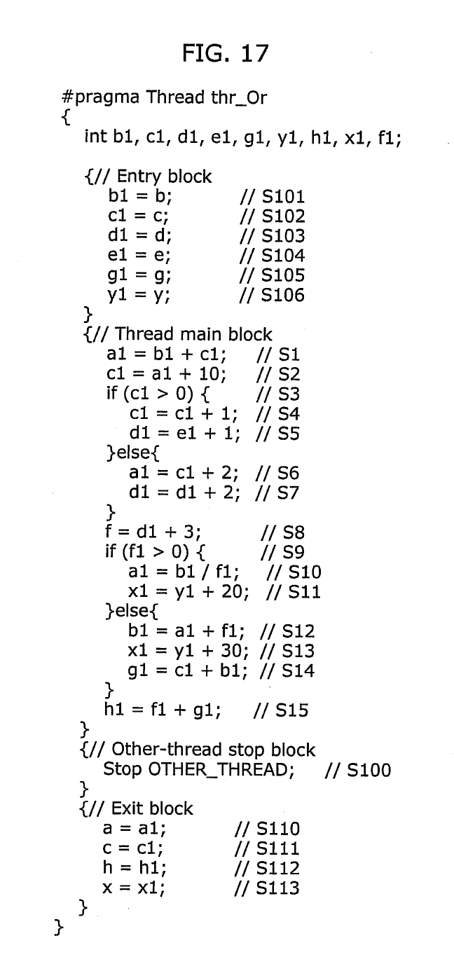

Next, the thread variable replacement unit 110 is activated. As a result of the processing performed by the thread variable replacement unit 110, the program shown in FIG. 16 is converted into a program shown in FIG. 17.

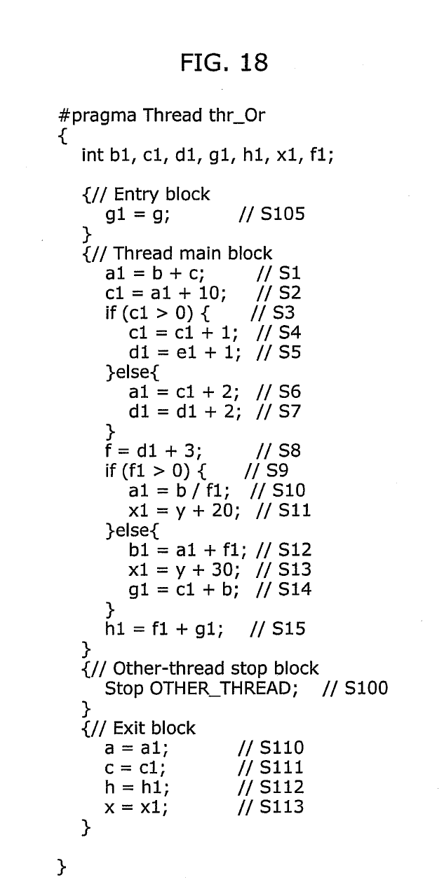

Then, as in the case with the thread thr_X, the entry block optimization unit 112 is activated to perform the copy propagation and dead code elimination on each of the statements in the entry block in FIG. 17. As a result, the program shown in FIG. 17 is converted into a program shown in FIG. 18.

Accordingly, the processing of generating the thread thr_Or is terminated. It should be noted that the instruction scheduling may be performed by calculating a general dependency relation among the the statements included in the entry block, thread main block, and exit block of the thread thr_Or.

Next, processing for the parallel execution of the thread thr_Or and the thread thr_X generated thus far is explained as follows.

The thread parallelization unit 102 arranges a plurality of threads generated by the thread generation unit 101 in such a way that the threads are executed in parallel, and thus generates a program which is equivalent to the specific program part and which can be executed at an enhanced speed. Moreover, a specific thread which is to be stopped in the other-thread stop block is determined here.

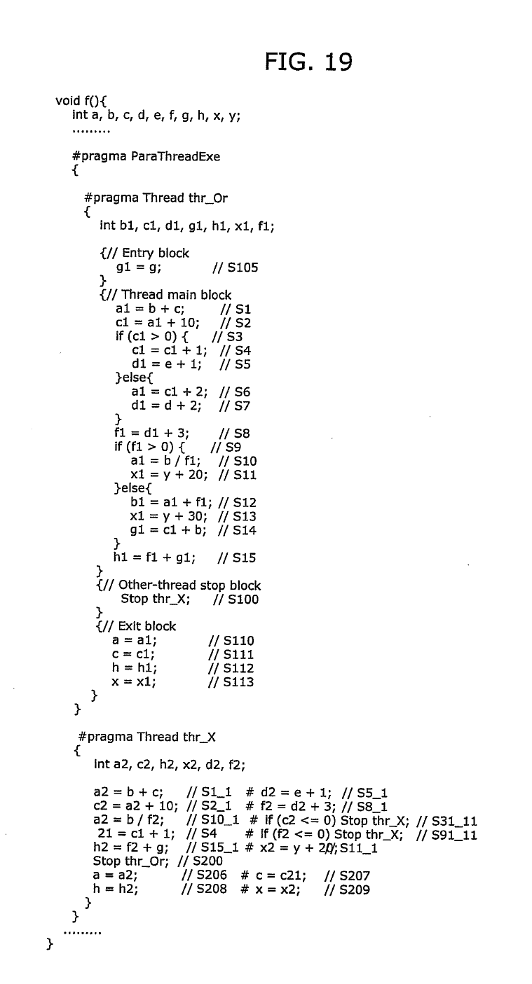

FIG. 19 shows a result of processing performed on the thread thr_X in FIG. 14 and the thread thr_Or in FIG. 18 by the thread parallelization unit 102.

In FIG. 19, “#pragma ParaThreadExe { . . . }” indicates that the threads inside the curly brackets are to be executed in parallel. To be more specific, as shown in FIG. 19, two threads, namely, the thread thr_Or and the thread thr_X, are arranged inside the curly brackets, which means that these two threads are to be executed in parallel. Moreover, the thread thr_X is determined as “OTHER_THREAD” of the statement S100 “Stop OTHER_THREAD” in FIG. 18, and is set in the statement S100 as shown in FIG. 19. Similarly, the thread thr_Or is determined as “OTHER_THREAD” of the statement S200 “Stop OTHER_THREAD” in the thread thr_X of FIG. 14, and is set in the statement S200 as shown in FIG. 19.

As described thus far, the program conversion apparatus 1 in the present embodiment can achieve: the thread generation such that the generated threads do not contend for access to a shared memory; the instruction generation for thread execution control; and the scheduling of the instructions of the thread.

As compared to the case of requiring ten steps for the execution of the path X before conversion, the program conversion apparatus 1 in the present invention allows the thread thr_X to be executed in eight steps. Moreover, when the path X is not executed, the thread thr_Or is executed, meaning that the execution is equivalent to the one before conversion. Note that, as compared to the program before conversion, the thread thr_Or has an increased number of steps because of the added entry block, other-thread stop block, and exit block. However, in the case where the path X is executed quite frequently, it is advantageous to perform the threading as shown in FIG. 19 since the average execution time becomes shorter.

As shown in FIG. 14, the statement S10_1 is executed before the statement S91_11. Here, when the value held by the variable f2 is zero, a zero divide exception occurs during the execution. When such an exception occurs during the execution, the processor or operating system may automatically stop the thread when detecting the exception.

Alternatively, as with the method disclosed in Japanese Unexamined Patent Application Publication No. 2008-4082 (referred to as Patent Reference 2), the special dependency generation unit 114 may generate a dependency such that a statement causing an exception during the execution (such as the statement S10_1 in FIG. 14) is not executed before a determination statement preventing the exception (such as the statement S91_11 in FIG. 14).

To be more specific, the special dependency generation unit 114 generates a dependency from the determination statement preventing the exception to the statement causing the exception. In the dependency graph shown in FIG. 12, a dependency is represented by an arrow from the statement S91_11 to the statement S10_1.

### First Modification

In the above embodiment, the path information includes information on a path only. However, the path information may be expanded so as to use variable information which includes a variable existing in the path and a constant value predetermined for the variable.

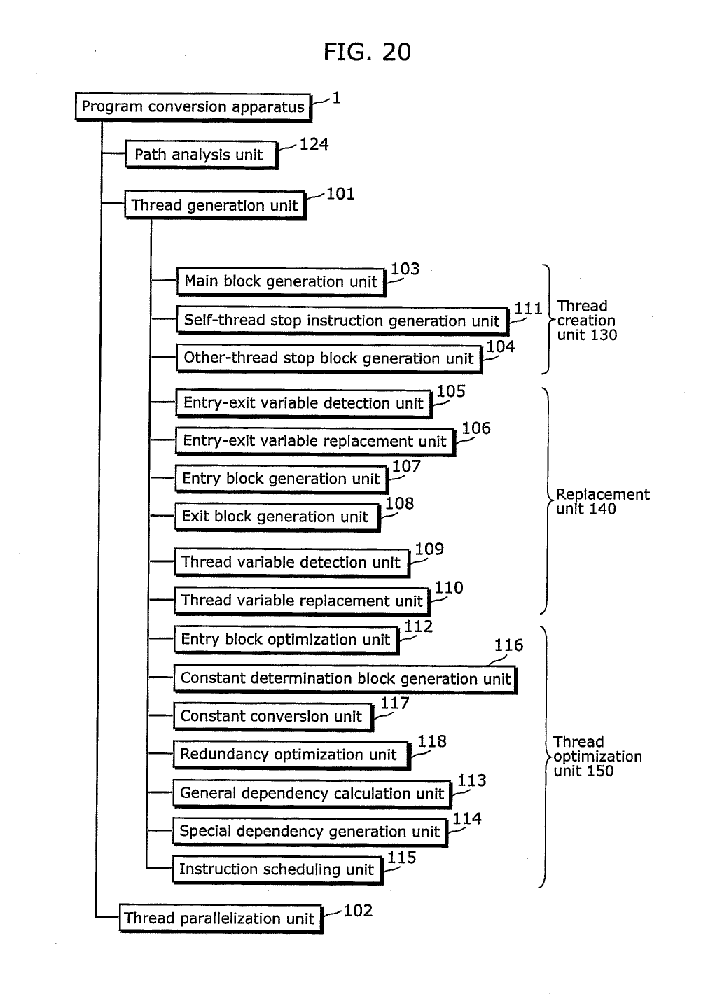

FIG. 20 is a diagram showing a hierarchical configuration of a program conversion apparatus in the present modification. A program conversion apparatus 1 in the present modification is different from the program conversion apparatus 1 in the above embodiment in that a constant determination block generation unit 116, a constant conversion unit 117, and a redundancy optimization unit 118 are added.

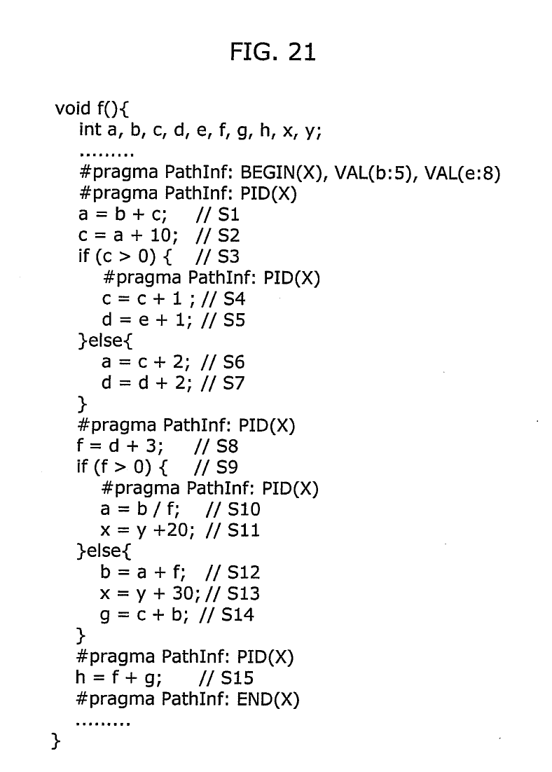

FIG. 21 is a diagram showing an example of a source program in which variable information is added to the path information by the programmer. In this diagram, “#pragma PathInf: BEGIN(X), VAL(b:5), VAL(e:8)” indicates that the variables b and e hold values 5 and 8 in the path X, respectively.

The path analysis unit 124 has a variable analysis unit which is not included in the above embodiment. The variable analysis unit determines a value held by a variable from the variable information. To be more specific, in the case shown in FIG. 21, the path analysis unit 124 analyzes “#pragma PathInf: BEGIN(X), VAL(b:5), VAL(e:8)”, and determines that the variables b and e hold the values 5 and 8 in the path X.

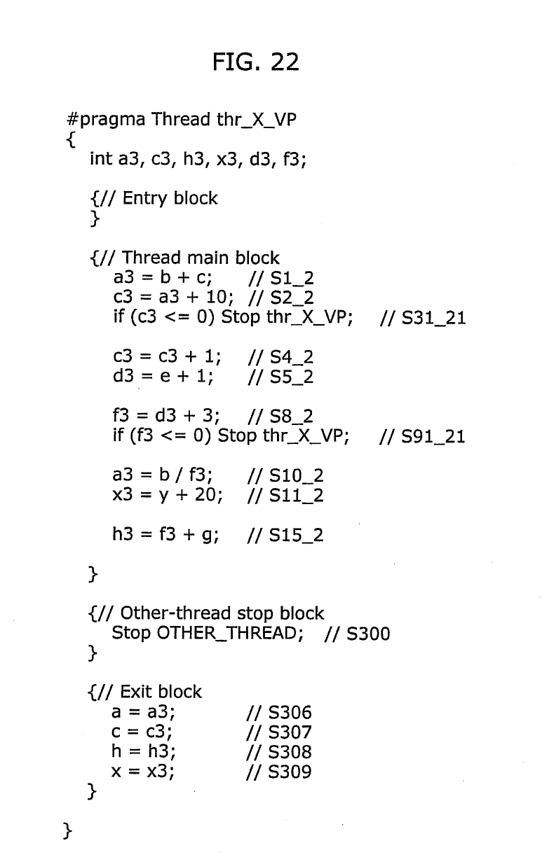

From the process performed by the main block generation unit 103 to the process performed by the entry block optimization unit 112 are the same as those performed in the above embodiment. More specifically, the same result as shown in FIG. 11 is obtained for the path X. Here, in order to avoid confusion with the conversion result shown in FIG. 11, FIG. 22 shows the result in the present modification by copying the result shown in FIG. 11. Note that, as shown in FIG. 22, the thread name is changed to a thr_X_VP and the variable names used in the thread are also changed. The conversion process is described with reference to FIG. 22 as follows.

The constant determination block generation unit 116 generates a constant determination block, and then arranges this block before the beginning of the entry block. Here, the constant determination block includes: an instruction to determine whether a value of a variable existing in the path is equivalent to a constant value predetermined for the variable in the variable information; and an instruction to stop the self-thread when the value of the variable is determined to be different from the predetermined constant value.

The constant conversion unit 117 replaces the variable in the thread main block with the predetermined constant value at its reference location, for each of the variables included in the variable information.

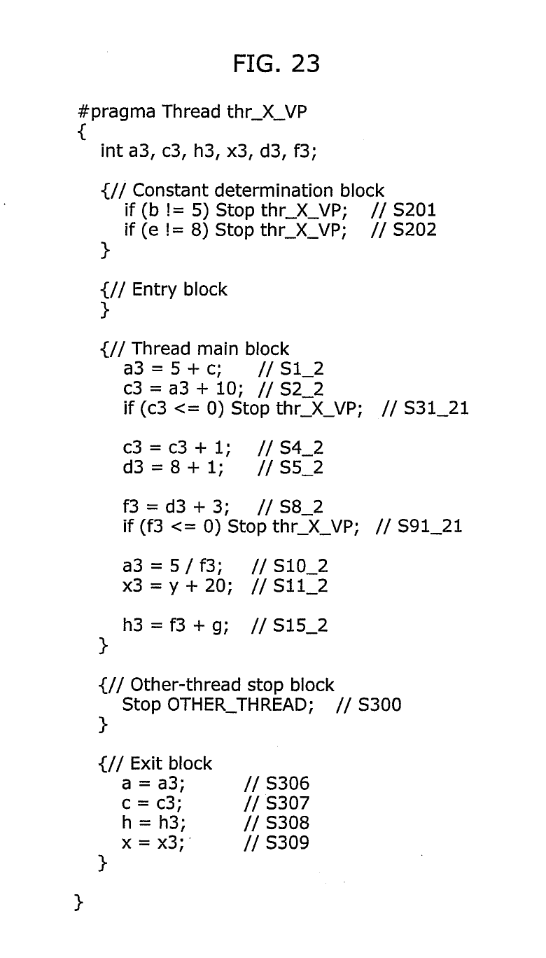

FIG. 23 shows a result of processing performed on the program shown in FIG. 22 by the constant determination block generation unit 116 and the constant conversion unit 117. As shown by the constant determination block in FIG. 23, when the value of the variable b is not 5 or when the value of the variable e is not 8, the instruction to stop the thread thr_X_VP is generated. Also as shown in FIG. 23, the variables b and e in the thread main block are replaced with the constant values 5 and 8 at their reference locations, respectively.

The redundancy optimization unit 118 performs typical optimization on the entry block, thread main block, and exit block, through constant propagation and constant folding. After the optimization through constant propagation and constant folding, an unnecessary instruction is deleted and an unnecessary branch is deleted in the case where a determination condition of a conditional is branch instruction is valid or invalid. In particular, in the case where the self-thread stop instruction is executed when the determination condition of the conditional branch instruction is satisfied and where the determination condition is valid, the self-thread stop instruction is always executed. On this account, the thread generation using the variable information is canceled.

The typical optimization through constant propagation in the present modification is the same as the one disclosed in Non-Patent Reference 2. This technique is not a principal objective of the present invention and thus is not explained here.

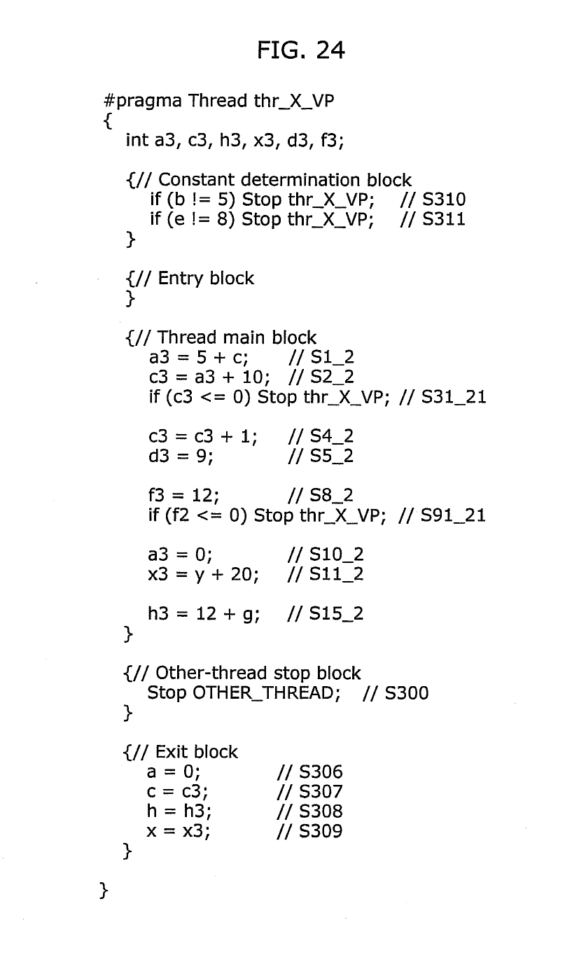

FIG. 24 shows a result of the constant propagation and constant folding included in the optimization performed by the redundancy optimization unit 118. As shown in FIG. 24, the constant folding performed on the statement S5_2 results in “d3=9”, and the constant propagation and constant folding of the statement S5_2 thus changes the statement S8_2 into “f3=12”. Moreover, the constant propagation of the statement S8_2 changes the determination condition of the statement S91_21 into “12<=0”. The other changes in FIG. 24 can be explained similarly.

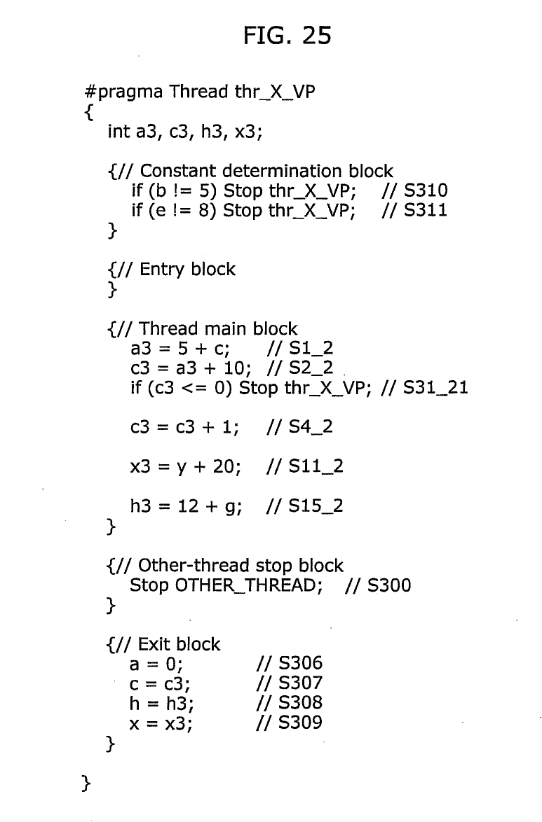

FIG. 25 shows a result of the remaining optimization performed on the program shown in FIG. 24 by the redundancy optimization unit 118. The statement S5_2 in FIG. 24 has no reference location for the variable d3 and therefore is deleted in the processing of unnecessary instruction deletion as shown in FIG. 25. Similarly, the statements S8_2 and S10_2 in FIG. 24 are deleted for this same reason, as shown in FIG. 25. Also, since the determination condition of the statement S91_21 is determined to be invalid, this statement is deleted as shown in FIG. 25.

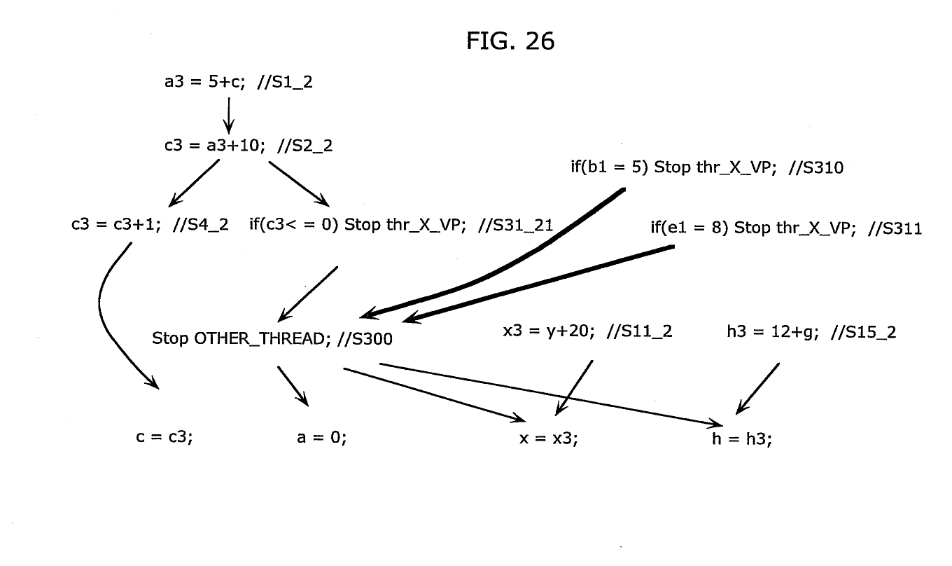

Next, the general dependency calculation unit 113, the special dependency generation unit 114, and the instruction scheduling unit 115 are activated in this order. In particular, the special dependency generation unit 114 generates a special dependency such that the instructions included in the constant determination block generated by the constant determination block generation unit 116 are executed before the execution of the instruction generated by the other-thread stop block generation unit 104. FIG. 26 shows a dependency graph of the program shown in FIG. 25. In this graph, the dependencies indicated by thick arrows from the statements S310 and S311 to the statement S300 are newly generated.

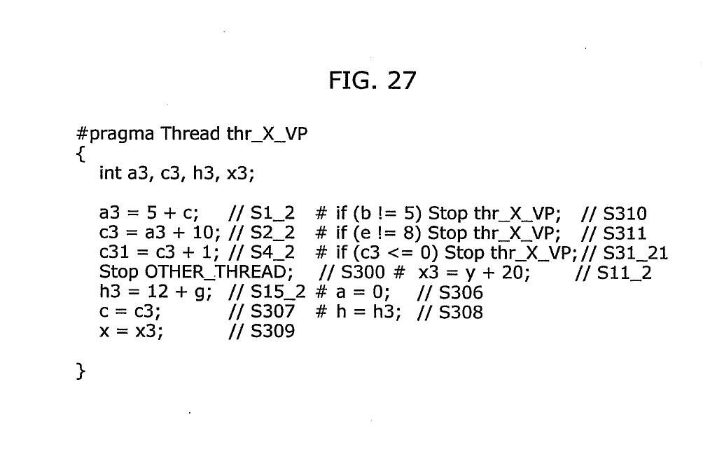

FIG. 27 shows a result of scheduling performed on the program shown in FIG. 25. As compared to the case shown in FIG. 14 in which the variable information is not used as the path information, the number of steps is reduced by one step to seven steps.

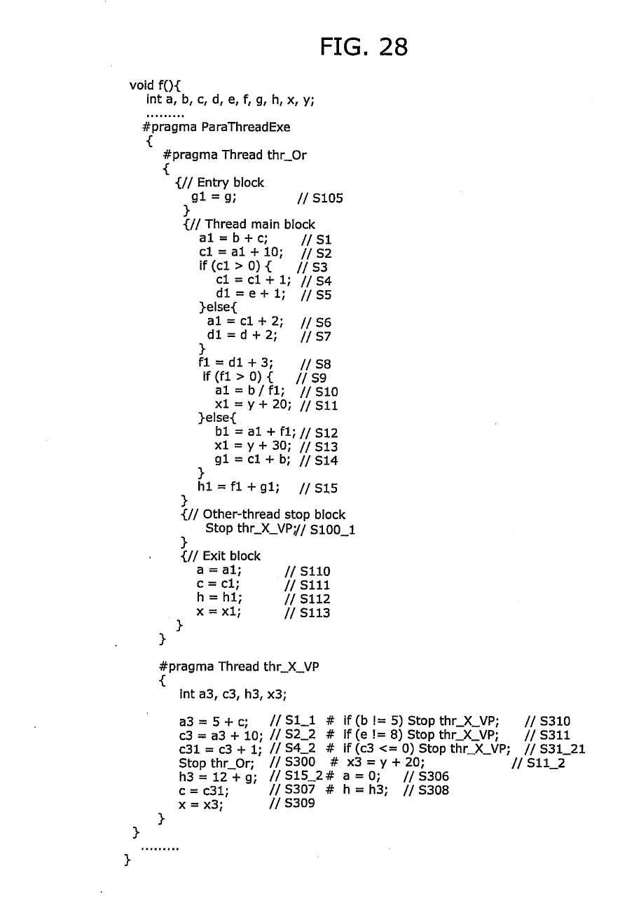

FIG. 28 shows a result of processing performed on the thread thr_X_VP in FIG. 27 and the thread thr_Or in FIG. 17 by the thread parallelization unit 102.

As described thus far, the program conversion apparatus 1 in the first modification can execute a thread in a short time by optimizing the thread using the variable information which includes a variable existing in the path and a constant value predetermined for the variable.

### Second Modification

In the above embodiment, the thread thr_Or is generated by threading the program part from the statement 51 to the statement S15 in the source program shown in FIG. 5, so as to be executed in parallel with the thread thr_X and the thread thr_X_VP. With this, in the above embodiment, even when the thread thr_X or the thread thr_X_VP is stopped, the thread thr_Or does not stop, thereby ensuring the execution equivalent to the execution of the part from the statement S1 to the statement S15 in the source program.

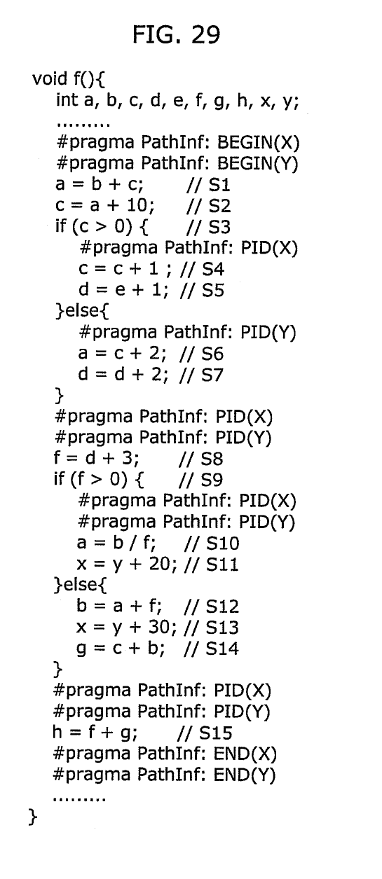

However, generally speaking, there may be a case where a plurality of paths are designated as shown in FIG. 29. In such a case, all paths in the source program do not need to be threaded. More specifically, the thread thr_Or in the above example can be simplified. The detailed explanation is given with reference to the drawings.

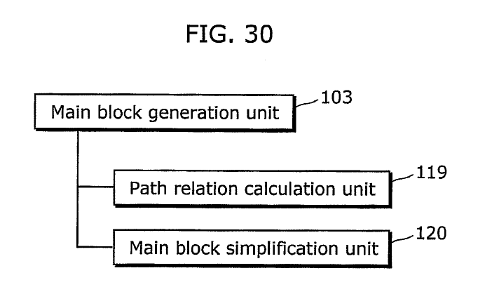

FIG. 30 is a diagram showing a hierarchical configuration of a main block generation unit 103 of a program conversion apparatus in the present modification. The main block generation unit 103 newly includes a path relation calculation unit 119 and a main block simplification unit 120.

The path relation calculation unit 119 calculates a thread inclusion relation. Firstly, for each of the paths designated in the path information, all subpaths taken during the execution of the path are extracted.

The subpath of the path X shown in FIG. 29 is: S1 ( ) S2 ( ) S3 ( ) S4 ( ) S5 ( ) S8 ( ) S9 ( ) S10 ( ) S11 ( ) S15. The subpath of the path Y shown in FIG. 29 is: S1 ( ) S2 ( ) S3 ( ) S6 ( ) S7 ( ) S8 ( ) S9 ( ) S10 ( ) S11 ( ) S15.

Moreover, there are four subpaths in a path (referred to as the path Or for the sake of convenience) from the statement S1 immediately after the start points (BEGIN(X) and BEGIN(Y)) of the paths X and Y to the statement S15 immediately before the end points (END(X) and END(Y)) of the paths X and Y as follows.

Subpath 1: S1 ( ) S2 ( ) S3 ( ) S4 ( ) S5 ( ) S8 ( ) S9 ( ) S10 ( ) S11 ( ) S15 (identical to the path X)

Subpath 2: S1 ( ) S2 ( ) S3 ( ) S6 ( ) S7 ( ) S8 ( ) S9 ( ) S10 ( ) S11 ( ) S15 (identical to the path Y)

Subpath 3: S1 ( ) S2 ( ) S3 ( ) S4 ( ) S5 ( ) S8 ( ) S9 ( ) S12 ( ) S13 ( ) S14 ( ) S15

Subpath 4: S1 ( ) S2 ( ) S3 ( ) S6 ( ) S7 ( ) S8 ( ) S9 ( ) S12 ( ) S13 ( ) S14 ( ) S15

It should be understood that both of the paths X and Y are calculated to be included in the path Or.

Here, suppose that “#pragma PathInf: PID(X)” immediately after the statement S3 is not described. In this case, the path X has the following two subpaths.

Subpath 1: S1 ( ) S2 ( ) S3 ( ) S4 ( ) S5 ( ) S8 ( ) S9 ( ) S10 ( ) S11 ( ) S15

Subpath 2: S1 ( ) S2 ( ) S3 ( ) S6 ( ) S7 ( ) S8 ( ) S9 ( ) S10 ( ) S11 ( ) S15 (identical to the path Y)

Accordingly, the path Y is also included in the path X here.

When it is determined from the thread inclusion relation that a first thread includes a second thread, the main block simplification unit 120 generates a thread main block in which a path that is also included in the second thread has been deleted from the first thread and an unnecessary instruction has been deleted as well.

Since the paths X and Y in FIG. 29 are threaded, the subpaths 1 and 2 equivalent to the paths X and Y among the subpaths of the path Or are deleted. As a result, the path Or is reconstructed based on the paths 3 and 4.

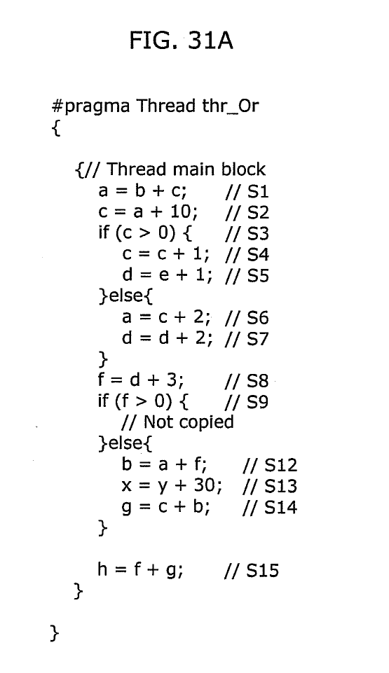

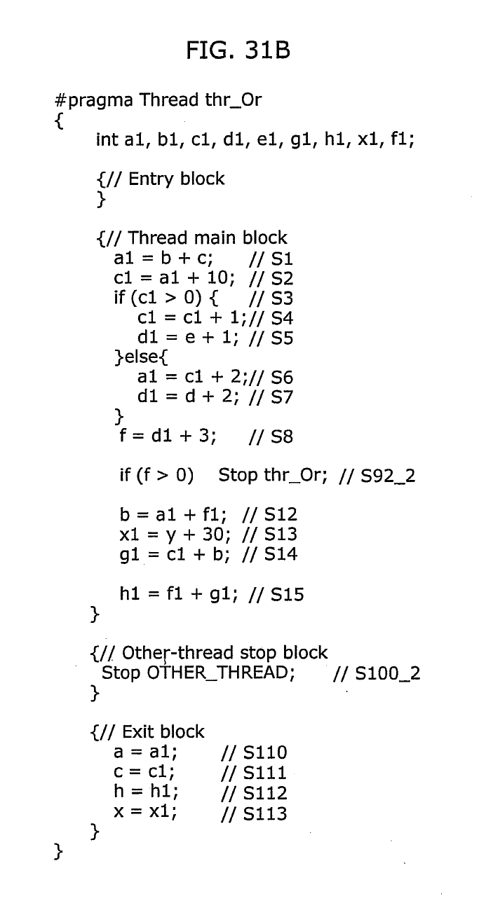

FIG. 31A is a diagram showing the thread main block of the thread thr_Or corresponding to the path Or. The statements S10 and S11 which do not exist in the subpaths 3 and 4 are not copied. FIG. 31B shows a result of processing performed on the generated thread thr_Or by the self-thread stop instruction generation unit 111, the other-thread stop block generation unit 104, the entry-exit variable detection unit 105, the entry-exit variable replacement unit 106, the entry block generation unit 107, the exit block generation unit 108, the thread variable detection unit 109, the thread variable replacement unit 110, and the entry block optimization unit 112.

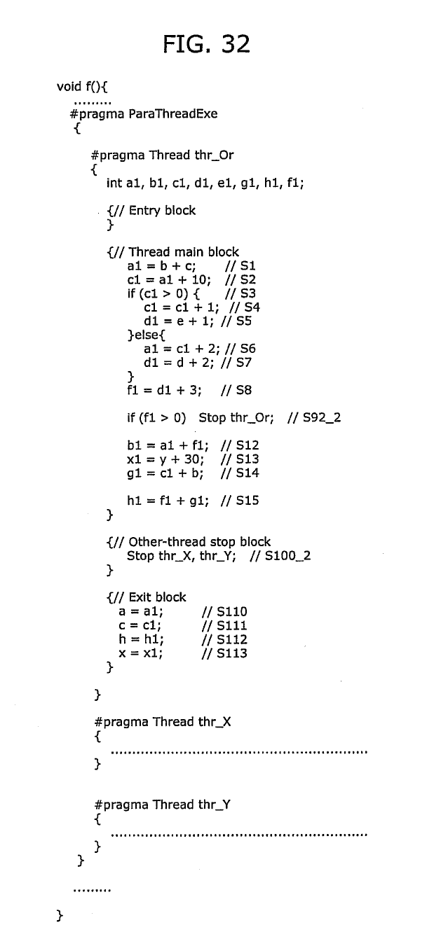

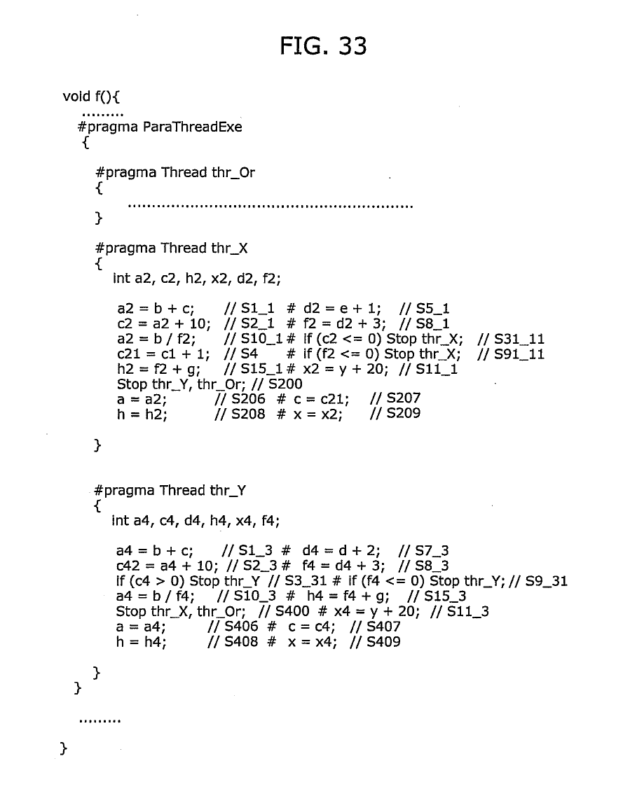

Each of FIGS. 32 and 33 shows a result of processing performed on the program shown in FIG. 29 by the units up to the thread parallelization unit 102. As shown, the conversion is performed so that the threads thr_Or, thr_X, and thr_Y are executed in parallel. The thread thr_Or shown in FIG. 32 is simplified as compared to the one shown in FIG. 19.

In the present modification described thus far, even when a specific thread is stopped, minimum necessary execution is achieved for the remaining thread. Accordingly, the program conversion apparatus in the present embodiment can reduce the execution time of the remaining thread.

### Third Modification

In the first modification, the variable information that includes a variable existing in the path and a constant value predetermined for the variable is used as the path information. Here, probability information, which shows both a path execution probability and a probability that a valuable holds a specific value, may be used as the path information.

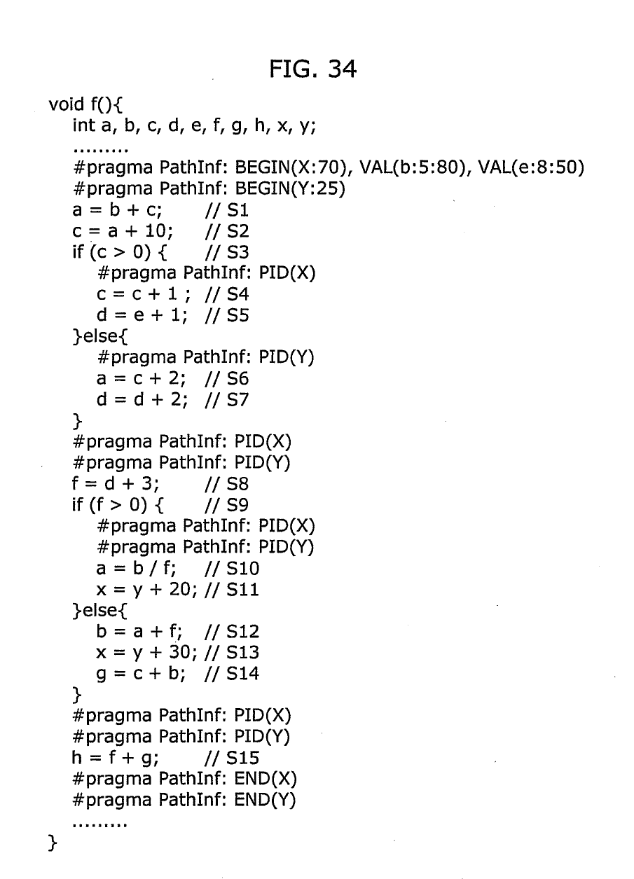

FIG. 34 is a diagram showing an example of a source program in which path execution probabilities and probabilities that the variables hold specific values in the path are added by the programmer. In the present diagram, “#pragma PathInf: BEGIN(X:70), VAL(b:5:80), VAL(e:8:50)” indicates that: the execution probability of the path X is 70%; the probability that the variable b holds the value 5 in the path X is 80%; and the probability that the variable e holds the value 8 in the path X is 50%. Also, “#pragma PathInf: BEGIN(Y:25)” indicates that the execution probability of the path Y is 25%.

The path analysis unit 124 has a probability determination unit which is not included in the first modification. The probability determination unit determines a path execution probability and a probability that a variable holds a specific value in the path. To be more specific, in the case shown in FIG. 34, the probability determination unit analyzes “#pragma PathInf: BEGIN(X:70), VAL(b:5:80), VAL(e:8:50)”, and determines that: the execution probability of the path X is 70%; the probability that the variable b holds the value 5 in the path X is 800%; and the probability that the variable e holds the value 8 in the path X is 50%. Also, the probability determination unit determines that the execution probability of the path Y is 25%.

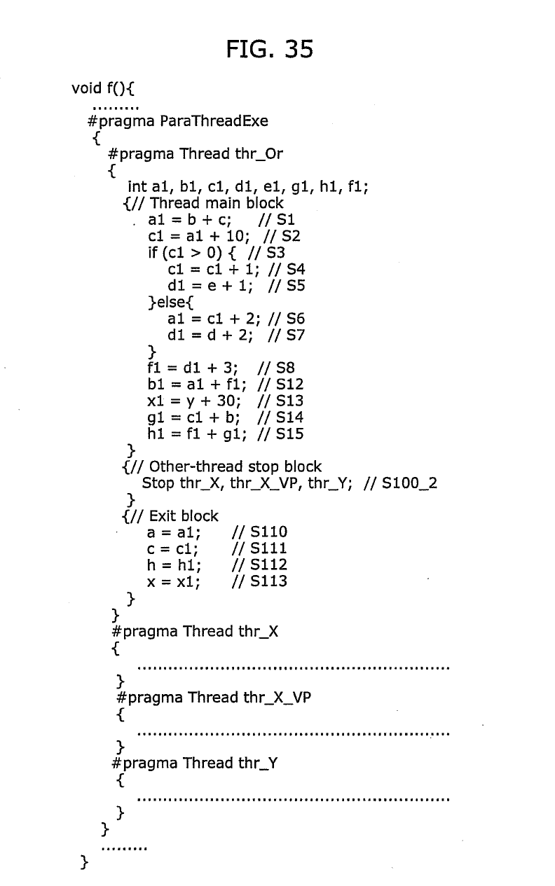

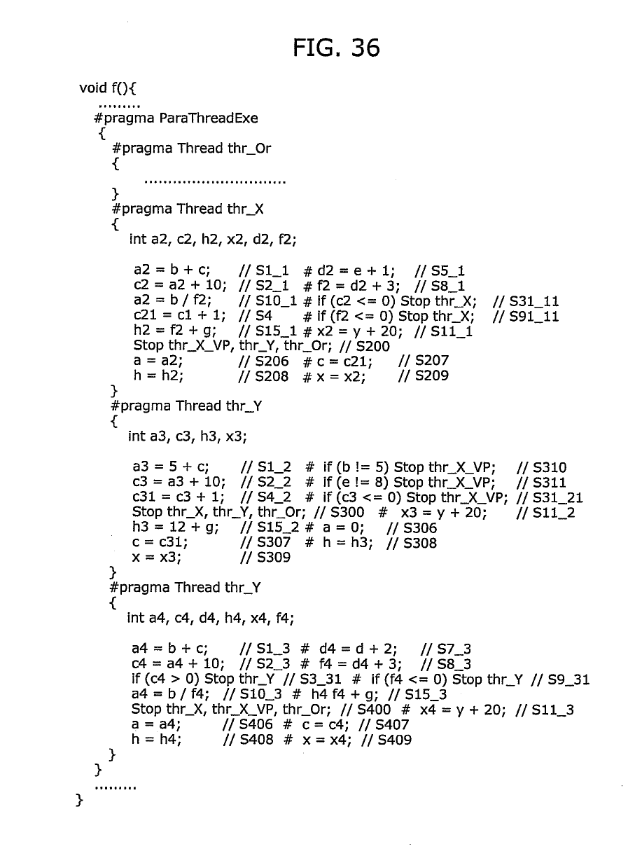

The operation performed by the thread generation unit 101 is the same as the one described in the above embodiment and modifications. As a result of this operation, the threads thr_X_VP, thr_Or, thr_X and thr_Y shown in FIGS. 27, 32, and 33 are generated. FIGS. 35 and 36 show results of the generated threads.

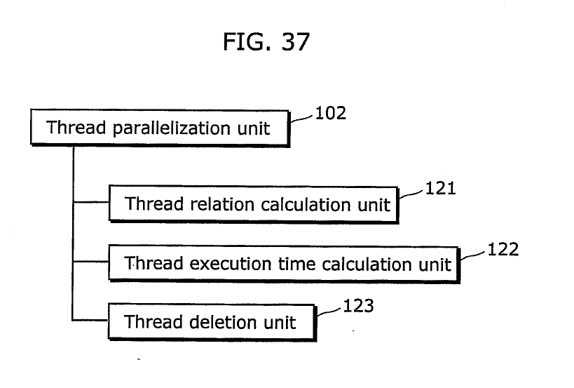

FIG. 37 is a diagram showing a hierarchical configuration of a thread parallelization unit 102 of a program conversion apparatus in the present modification. The thread parallelization unit 102 newly includes a thread relation calculation unit 121, a thread execution time calculation unit 122, and a thread deletion unit 123.

The thread relation calculation unit 121 determines, from first and second threads generated by the thread generation unit 101, whether a path equivalent to the first thread is included in a path equivalent to the second thread. When determining so, the thread relation calculation unit 121 calculates a thread inclusion relation by considering that the first thread is included in the second thread.

To be more specific, the thread inclusion relation is calculated using the path inclusion relation calculated by the path relation calculation unit 119 in the second modification above. That is, when the path 1 equivalent to the first thread includes the path 2 equivalent to the second thread, it is determined that the first thread includes the second thread.

Moreover, in the first modification, on the basis of a third thread before the replacement using the predetermined constant value and a fourth thread after the replacement, the thread inclusion relation is calculated by determining that the third thread includes the fourth thread. For example, the thread thr_X_VP shown in FIG. 36 is specialized so that the value of the variable b replaced with the value 5 and the value of the variable e is replaced with the value 8 in the path X. Thus, the thread thr_X_VP is included in the thread thr_X. The thread execution time calculation unit 122 calculates an average execution time of the generated thread, using the path information including the path execution probability and the probability that the variable holds the specific value.

The average execution times of the threads thr_Or, thr_X, thr_X_VP, and thr_Y shown in FIGS. 35 and 36 are calculated as follows.

Average execution time of thr_X . . . Tx*Px

Average execution time of thr_X_VP . . . Tx*Pxv

Average execution time of thr_Y . . . Ty*Py

Average execution time of thr_Or . . . Tor*Por

Here, Tx, Ty, and Tor represent the execution times of the threads thr_X, thr_Y, and thr_Or, respectively. Also, Px represents 70% which is the execution probability of the path X, and Py represents 25% which is the execution probability of the path Y. Moreover, Por represents a probability in the case where a path other than the paths X and Y is executed, and thus 5%. Furthermore, Pxv represents a probability that the variables b and e in the path X hold the values 5 and 8 respectively, and thus 28% (i.e., 70%*80%*50%).

When it is determined, from the thread inclusion relation between first and second generated threads, that the first thread is included in the second thread and that the average execution time of the second thread is shorter than that of the first thread, the thread deletion unit 123 deletes the first thread.

In the case shown in FIG. 36, the thread thr_X_VP is included in the thread thr_X. On this account, when the average execution time of the thread thr_X_VP is equal to or longer than that of the thread thr_X, the thread thr_X_VP is deleted.

Although the embodiment and first to third modifications have been described thus far, the present invention is not limited these. The present invention includes other embodiments implemented by applying various kinds of modifications conceived by those skilled in the art or by combining the components of the above embodiment and modifications without departing from the scope of the present invention.

It should be noted that although the path information is given by the programmer in the above embodiment and modifications, the path information may be given to the program conversion apparatus from an execution tool such as a debugger or a simulator. Also, instead of receiving from the source program, the program conversion apparatus may receive the path information as, for example, a path information file which is separated from the source program.

Moreover, an instruction code may be added to the assembler program. Furthermore, the shared memory may be a centralized shared memory or a distributed shared memory.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

As described above, the program conversion apparatus according to the present invention reconstructs a specific part of a source program using a plurality of threads which are equivalent to the specific part and which do not contend for access to a shared storage area. Then, the optimization conversion and the instruction-level parallelization conversion are performed for each of the threads, so that the plurality of threads are executed in parallel. Accordingly, the present invention has an advantageous effect of generating a program whose specific part of a source program can be executed at an enhanced speed, and is useful as a program conversion apparatus and the like.

1 Program conversion apparatus

101 Thread generation unit

102 Thread parallelization unit

103 Main block generation unit

104 Other-thread stop block generation unit

105 Entry-exit variable detection unit

106 Entry-exit variable replacement unit

107 Entry block generation unit

108 Exit block generation unit

109 Thread variable detection unit

110 Thread variable replacement unit

111 Self-thread stop instruction generation unit

112 Entry block optimization unit

113 General dependency calculation unit

114 Special dependency generation unit

115 Instruction scheduling unit

116 Constant determination block generation unit

117 Constant conversion unit

118 Redundancy optimization unit

119 Path relation calculation unit

120 Main block simplification unit

121 Thread relation calculation unit

122 Thread execution time calculation unit

123 Thread deletion unit

124 Path analysis unit

130 Thread creation unit

140 Replacement unit

150 Thread optimization unit

200 Computer system

201 Storage unit

202 Conversion program

203 Source program

204 Processor

205 Memory

207 Object program

210 Compiler system

211 Compiler

212 Assembler

213 Linker

215 Assembler program

216 Relocatable binary program

300 Conventional thread example

301 Conventional thread example

302 Conventional thread example

303 Conventional thread example

What is claimed is:

1. A program conversion apparatus comprising:
a thread creation unit configured to create a plurality of threads equivalent to a program part included in a program, based on path information on a plurality of execution paths, each of the execution paths going from a start to an end of the program part, each of the threads being equivalent to at least one of the execution paths;
a replacement unit configured to perform variable replacement on the threads so that a variable shared by the threads is accessed by only one of the threads in order to avoid an access conflict among the threads; and
a thread parallelization unit configured to generate a program which causes the threads to be speculatively executed in parallel after the variable replacement.

2. The program conversion apparatus according to claim 1,
wherein said thread creation unit includes:
a main block generation unit configured to generate a thread main block which is a main body of a thread, by copying an instruction included in one of the execution paths of the program part; and
an other-thread stop block generation unit configured to generate an other-thread stop block including an instruction for stopping an execution of an other thread, and to arrange the other-thread stop block after the thread main block, and
said replacement unit includes:
an entry-exit variable detection unit configured to detect an entry live variable and an exit live variable which are live at a beginning and an end of the thread main block, respectively;
an entry-exit variable replacement unit configured to generate a new variable for each of the detected entry and exit live variables, and to replace the detected live variable with the new variable in the thread main block;
an entry block generation unit configured to generate an entry block including an instruction for assigning a value held by the detected entry live variable to the new variable generated by said entry-exit variable replacement unit, and to arrange the entry block before the thread main block;
an exit block generation unit configured to generate an exit block including an instruction for assigning a value held by the new variable generated by said entry-exit variable replacement unit to the detected exit live variable, and to arrange the exit block after the other-thread stop block;
a thread variable detection unit configured to detect a thread live variable which is not detected by said entry-exit variable detection unit and which occurs in the thread main block; and
a thread variable replacement unit configured to generate a new variable for the detected thread live variable and to replace the detected thread live variable with the new variable in the thread main block.

3. The program conversion apparatus according to claim 2,
wherein said thread creation unit further includes
a self-thread stop instruction generation unit configured, when a branch target instruction of a conditional branch instruction in the thread main block does not exist in the execution path of the thread main block, to generate a self-thread stop instruction, as the branch target instruction, in order to stop the thread, and to arrange the self-thread stop instruction in the thread main block.

4. The program conversion apparatus according to claim 3,
wherein, when the branch target instruction of the conditional branch instruction which branches when a determination condition is not satisfied does not exist in the execution path of the thread main block, the self-thread stop instruction generation unit is further configured to: reverse the determination condition of the conditional branch instruction; generate a self-thread stop instruction, as the branch target instruction, in order to stop the thread for a case where the reversed determination condition is satisfied; and arrange the self-thread stop instruction in the thread main block.

5. The program conversion apparatus according to claim 2, further comprising
a thread optimization unit configured to optimize the instructions in the threads on which the variable replacement has been performed by said replacement unit, so that the instructions are executed more efficiently,
wherein said thread parallelization unit is configured to generate a program that causes the threads optimized by said thread optimization unit to be speculatively executed in parallel.

6. The program conversion apparatus according to claim 5,
wherein said thread optimization unit includes
an entry block optimization unit configured to perform optimizations of copy propagation and dead code elimination on: the instruction of the entry block in the thread on which the variable replacement has been performed; the thread main block; and the exit block.

7. The program conversion apparatus according to claim 5,
wherein said thread optimization unit further includes:
a general dependency calculation unit configured to calculate a dependency relation among the instructions of the threads on which the variable replacement has been performed by said replacement unit, based on a sequence of updates and references performed on the instructions in the threads;
a special dependency generation unit configured to generate a dependency relation such that the instruction in the other-thread stop block is executed before the instruction in the exit block is executed and a dependency relation such that the self-thread stop instruction is executed before the instruction in the other-thread stop block is executed; and
an instruction scheduling unit configured to parallelize the instructions in the threads, according to the dependency relation calculated by said general dependency calculation unit and the dependency relations generated by said special dependency generation unit.

8. The program conversion apparatus according to claim 2,
wherein the path information includes a variable existing in the execution path and a constant value predetermined for the variable,
said program conversion apparatus further comprises:
a constant determination block generation unit configured to generate a constant determination block and arrange the constant determination block before the entry block, the constant determination block including: an instruction for determining whether a value of the variable is equivalent to the constant value; and an instruction for stopping the thread when the value of the variable is not equivalent to the constant value; and
a constant conversion unit configured to convert the variable in the thread main block into the constant value, and
said thread parallelization unit is configured to generate a program that causes the threads to be speculatively executed in parallel after the conversion.

9. The program conversion apparatus according to claim 7,
wherein the path information includes a variable existing in the execution path and a constant value predetermined for the variable,
said program conversion apparatus further comprises:
a constant determination block generation unit configured to generate a constant determination block and arrange the constant determination block before the entry block, the constant determination block including: an instruction for determining whether a value of the variable is equivalent to the constant value; and an instruction for stopping the thread when the value of the variable is not equivalent to the constant value; and
a constant conversion unit configured to convert the variable in the thread main block of the thread into the constant value when said constant determination block generation unit determines that the value of the variable is equivalent to the constant value, and
said thread parallelization unit is configured to generate a program that causes the threads to be speculatively executed in parallel after the conversion.

10. The program conversion apparatus according to claim 9,
wherein said special dependency generation unit is further configured to generate a special dependency relation such that the instructions in the constant determination block are executed before the instruction in the other-thread stop block is executed.

11. The program conversion apparatus according to claim 2,
wherein the threads include a first thread and a second thread, and
said main block generation unit includes:
a path relation calculation unit configured to calculate a path inclusion relation between the first and second threads; and
a main block simplification unit configured to delete, from the first thread, a path included in both the first and second threads, when it is determined from the path inclusion relation that the first thread includes the second thread.

12. The program conversion apparatus according to claim 2,
wherein said thread parallelization unit includes:
a thread relation calculation unit configured to: determine whether an execution path equivalent to a first thread is included in an execution path equivalent to a second thread, the first and second threads being included in the threads; and calculate a thread inclusion relation between the first and second threads by determining that the first thread is included in the second thread when determining that the execution path equivalent to the first thread is included in the execution path equivalent to the second thread;
a thread execution time calculation unit configured to calculate an average execution time for each of the generated threads, using the path information including a path execution probability and a value probability that a variable holds a specific value; and
a thread deletion unit configured to delete the first thread, when the first thread is included in the second thread and the average execution time of the second thread is shorter than the average execution time of the first thread.

13. The program conversion apparatus according to claim 1,
wherein the program includes path identification information for identifying a path included in the program part, and
said program conversion apparatus further comprises
a path analysis unit configured to analyze the path identification information and extract the path information.

14. The program conversion apparatus according to claim 13,
wherein the program includes variable information indicating a value held by a variable existing in the execution path, and
said path analysis unit includes
a variable analysis unit configured to determine the value held by the variable, by analyzing the path identification information and the variable information.

15. The program conversion apparatus according to claim 12,
wherein the program includes: path identification information for identifying a path; execution probability information on the path; variable information indicating a value held by the variable existing in the path; and value probability information indicating a probability that the variable holds the specific value, and
said program conversion apparatus further comprises
a probability determination unit configured to determine the path execution probability and the value probability, according to the path identification information, the execution probability information, the variable information, and the value probability information.

16. A program conversion method comprising:
creating a plurality of threads equivalent to a program part included in a program, based on path information on a plurality of execution paths, each of the execution paths going from a start to an end of the program part, each of the threads being equivalent to at least one of the execution paths;
performing variable replacement on the threads so that a variable shared by the threads is accessed by only one of the threads in order that an access conflict among the threads is avoided; and
generating a program which causes the threads to be speculatively executed in parallel after the variable replacement.

17. The program conversion method according to claim 16,
wherein said creating includes:
generating a thread main block which is a main body of a thread, by copying an instruction included in one of the execution paths of the program part; and
generating an other-thread stop block including an instruction for stopping an execution of an other thread and arranging the other-thread stop block after the thread main block,
said performing of variable replacement includes:
detecting an entry live variable and an exit live variable which are live at a beginning and an end of the thread main block, respectively;
generating a new variable for each of the detected entry and exit live variables and replacing the detected live variable with the new variable in the thread main block;
generating an entry block including an instruction for assigning a value held by the detected entry live variable to the new variable generated in said generating of a new variable, and arranging the entry block before the thread main block;
generating an exit block including an instruction for assigning a value held by the new variable generated in said generating of a new variable to the detected exit live variable, and arranging the exit block after the other-thread stop block;
detecting a thread live variable which is not detected in said detecting and which occurs in the thread main block; and
generating a new variable for the detected thread live variable and replacing the detected thread live variable with the new variable in the thread main block,
said program conversion method further comprising
optimizing the instructions in the threads on which the variable replacement has been performed in said performing of variable replacement, so that the instructions are executed more efficiently,
said optimizing includes:
performing optimizations of copy propagation and dead code elimination on: the instruction of the entry block in the thread on which the variable replacement has been performed; the thread main block; and the exit block;
calculating a dependency relation among the instructions of the threads on which the variable replacement has been performed in said performing of variable replacement, based on a sequence of updates and references performed on the instructions in the threads;
generating a dependency relation such that the instruction in the other-thread stop block is executed before the instruction in the exit block is executed and a dependency relation such that the self-thread stop instruction is executed before the instruction in the other-thread stop block is executed; and
parallelizing the instructions in the threads, according to the dependency relation calculated in said calculating of a dependency relation and the dependency relations generated in said generating of dependency relations, and
in said generating of a program, a program that causes the threads optimized in said optimizing to be speculatively executed in parallel is generated.

18. The program conversion method according to claim 17,
wherein the path information includes a variable existing in the execution path and a constant value predetermined for the variable,
said program conversion method further comprises:
generating a constant determination block and arranging the constant determination block before the entry block, the constant determination block including: an instruction for determining whether a value of the variable is equivalent to the constant value; and an instruction for stopping the thread when the value of the variable is not equivalent to the constant value; and
converting the variable in the thread main block into the constant value, and
in said generating of a program, a program that causes the threads to be speculatively executed in parallel after the conversion is generated.

19. The program conversion method according to claim 18,
wherein, in said generating of dependency relations, a special dependency relation is further generated so that the instructions in the constant determination block are executed before the instruction in the other-thread stop block is executed.
